(19) United States
(12) Patent Application Publication
(10) Pub. No.: US 2019/0066046 A1
(43) Pub. Date: Feb. 28, 2019

(54) COMPUTER IMPLEMENTED SYSTEM AND METHOD FOR REAL TIME DELIVERY SEGMENTATION IN LOGISTICS

(71) Applicant: CURBER INC., San Francisco, CA (US)

(72) Inventor: Raj Deepak Nathani, San Francisco, CA (US)

(21) Appl. No.: 15/984,105

(22) Filed: May 18, 2018

Related U.S. Application Data
(60) Provisional application No. 62/550,144, filed on Aug. 25, 2017.

(51) Int. Cl. G06Q 10/08; G06N 7/00

(52) U.S. Cl. CPC G06Q 10/0836; G06N 7/005

(57) ABSTRACT

Computer implemented system(s) and method(s) for real time delivery segmentation in logistics are described herein. Data associated with each user of user devices are received. A dispatch request for a pick-up/drop-off is received from a requestor device. A set of user devices within a predefined distance of the pick-up location, or within a predefined distance from the transfer path (for a drop-off), or from any point on the vehicular path on route to the drop-off location (for an assisted drop-off) is identified. A score for each user device is computed based upon processing of data associated with each user device. The dispatch request for a pick-up/drop-off is transmitted to one or more user devices based upon the computed score. The requestor device and one of the set of user devices are notified with the transfer path (for a pick-up/drop-off), or an assisted embark location (for an assisted drop-off).

### CROSS-REFERENCE To RELATED APPLICATIONS AND PRIORITY

The present application claims priority from U.S. provisional patent application 62/550,144 filed on Aug. 25, 2017, the entirety of which is incorporated herein by a reference.

### TECHNICAL FIELD

The present subject matter, in general relates, to logistics, and more particularly, to a computer-implemented system and method for increasing throughput and efficiency in logistics by real time segmentation of a delivery, through identification of one or more user devices located within a predefined distance of vehicle(s) associated with logistical operations.

### BACKGROUND

Over the past two decades there has been a marked growth in the sector of e-commerce, with 9% of all retail purchases being done via e-commerce, the volume of which is estimated to nearly double to 17% by the year 2022. There are two points of note in this broad shift towards e-commerce, the first point of note is that the growth in this sector has resulted in numerous fulfillment centers and warehouses being established in close proximity to densely populated urban areas, where demand for products is correspondingly higher. This is done primarily to facilitate shorter delivery durations. The second point of note is that the breadth of services fulfilled by e-commerce has expanded horizontally to sectors of the economy which were inexistent before, for instance, online grocery deliveries, online restaurant food deliveries, and the like, performed by on-demand platforms such as those of GRUBHUB™, INSTACART™, UBEREATS™, and the like, respectively.

The overall increase in volume of deliveries taking place in densely populated urban areas has come with its upsides, particularly in terms of improved availability and expedited delivery of packages, however there have also been a few negative effects stemming from the fact that most urban infrastructures were not originally designed for such high volumes of package deliveries conducted throughout the day. For instance, while there hasn't been any notable change in the occupancy rates in parking lots, there has been a sharp increase in occupancy rates of on-street parking spots, this situation prevails for both picking up packages from restaurants, grocery stores, fulfillment centers, and the like, and for dropping off packages to residential buildings, office buildings, gated communities, and the like.

While there exist special loading zones at or near both residential and commercial buildings, these may not be available for delivery vehicles at all times of the day. To complete the collection or delivery of package(s), in one case, the operators of the delivery vehicle may navigate to a location further from the pick-up or drop-off location to locate a parking spot for the temporary parking of the respective delivery vehicle. In a second case, the operators of the delivery vehicle may resort to illegal parking of the delivery vehicle, either by double parking or parking in a non-permitted parking spot. Both the former and latter cases bear a strain on cities' traffic congestion and cities' traffic authorities, respectively.

One of the compromises reached in this practice of urban logistics, involves the delivery vehicle to be met by the sender or receiver of the packages(s) at the curbside for pick-ups and drop-offs. This approach alleviates issues for both the delivery personnel and the city traffic authorities, however in the presence of unpredictability of the arrival time of the sender/receiver at the pick-up/drop-off location on the curb, it can contribute to loss of time for the delivery provider. This is also compounded by the fact that deciding on a meeting point for the exchange of the package(s) is decided ad-hoc, in which in most cases this would be in close proximation to the pick-up or drop-off location. This ad-hoc selection could be lesser optimal than a meeting point selected dynamically based on real-time traffic levels at the pick-up or drop-off locations, the direction of the delivery vehicle relative to the side of the road on which the delivery vehicle is travelling on, and other such real-time data.

Non-human operated delivery vehicles such as those performed by autonomous vehicles, sidewalk robots, aerial drones (UAVs), and the like, are being introduced by delivery services. However, in these cases, the two aforementioned problems with curbside pick-ups/drop-offs are more pertinent due to the likelihood of lack of onboard human assistance upon the non-human operated vehicles.

Further, the current delivery mechanisms provide lack of control for certain locations to monitor the delivery of package(s) to their respective premises. Locations such as residential apartments, gated communities, and hotels, may enable security protocols for delivery of package(s) within their premises for the security of their respective premises, tenants, and/or residents. Since these locations lack information of the incoming third-party delivery personnel, these security protocols are usually conducted manually on a per-entry basis for each of the delivery personnel. This results in further time lost for the delivery personnel, on a repetitive per-entry basis.

In the existing art, there is no real-time solution that can sufficiently address these combined problems of unavailable parking spots, traffic congestion, and timely delivery of package(s). Additionally, there is time lost in terms of both productive delivery personnel hours worked and delivery vehicle usage in performing any of the aforementioned activities for the pick-up or drop-off of package(s), as delivery vehicles remain stalled, for durations of time outside of the pick-up or drop-off locations.

Therefore, there is a long-standing need of a system and a method to improve the logistical efficiency of collection and delivery of package(s) in densely populated urban areas. Further, there is a need of a system and a method of dispatch by considering predetermined and static factors, and relevant dynamic factors which change over time.

### SUMMARY

Before the present system and its method of use is described, it is to be understood that this disclosure is not limited to the apparatus, its arrangement, and method as described, as there can be multiple possible embodiments which are not expressly illustrated in the present disclosure. It is also to be understood that the terminology used in the description is for the purpose of describing the particular versions or embodiments only and is not intended to limit the scope of the present application. This summary is not intended to identify essential features of the subject matter nor it is intended for use in detecting or limiting the scope of the proposed subject matter.

In one embodiment, a computer implemented system for real time delivery segmentation in logistics is disclosed. The system may include a processor and a memory coupled with the processor. It must be noted herein that the processor may be implemented as a single processor or one or more processors. The processor may be communicatively coupled with a requestor device, and a plurality of user devices. The processor may execute a plurality of instructions stored in the memory. The processor may execute instructions for receiving data associated with each user of the plurality of user devices. The processor may further execute instructions for receiving a dispatch request for a pick-up from the requestor device. The processor may further execute instructions for recommending one or more transfer paths to the requestor device. Each transfer path is a polygonal chain of geospatial points. A transfer path from one or more transfer paths may be selected by the requestor device or the processor. The processor may further execute instructions for identifying the user devices associated with a set of users, of the plurality of users, located within a predefined distance of the pick-up location. The processor may further execute instructions for processing the data associated with each user of the set of users based upon predefined parameters to categorize the set of users into either a first data pool, a second data pool, or a third data pool. The processor may further execute instructions for computing normalized distance for the user device associated with each user of the set of users, categorized in either of the first data pool, the second data pool, or the third data pool, from the pick-up location. The processor further executes instructions for determining a probability of acceptance, of the dispatch request for a pick-up, by the user device associated with each user of the set of users, categorized in either of the first data pool, the second data pool, or the third data pool, by processing the data of the user device associated with each user of the set of users. The processor further executes instructions for computing a score for the user device associated with each user of the set of users based upon the normalized distance and the probability of acceptance of the user device associated with each user of the set of users. The processor may further execute instructions for transmitting, the dispatch request for a pick-up, to the user device associated with one or more users of the set of users based upon the score of each user device associated with the set of users. The processor may further execute instructions for receiving an acknowledgement message indicative of acceptance, of the dispatch request for a pick-up, by a user device associated with a user of the set of users. The processor may further execute instructions for notifying the requestor device with a confirmation message indicative of allocation, of the dispatch request for a pick-up, to the user device associated with the user of the set of users, based upon the receipt of the acknowledgement message. The processor may further execute instructions for communicating the selected transfer path with the requestor device and the user device associated with the user of the set of users.

In another embodiment, a computer implemented system for real time delivery segmentation in logistics is disclosed. The system may include a processor and a memory coupled with the processor. It must be noted herein that the processor may be implemented as a single processor or one or more processors. The processor may be communicatively coupled with a requestor device, and a plurality of user devices. The processor may be configured to execute a plurality of instructions stored in the memory. The processor may execute instructions for receiving data associated with each user of the plurality of user devices. The processor may further execute instructions for receiving a dispatch request for a drop-off from the requestor device. The processor may further execute instructions for recommending one or more transfer paths to the requestor device. Each transfer path is a polygonal chain of geospatial points. A transfer path from the one or more transfer paths may be selected by the requestor device or the processor. The processor may further execute instructions for checking whether a user device associated with one or more users of the plurality of users is located within a predefined distance from the closest geospatial point on the transfer path relative to the respective user device associated with the one or more users of the plurality of users. If the user device associated with the one or more users of the plurality of users is located within the predefined distance from the closest geospatial point on the transfer path relative to the respective user device associated with the one or more users of the plurality of users, then the processor may further execute instructions for identifying the user devices associated with a first set of users, of the plurality of users, located within the predefined distance from the closest geospatial point on the transfer path relative to the respective user device associated with each user of the plurality of users. The processor may further execute instructions for processing the data associated with each user of the first set of users based upon predefined parameters to categorize the first set of users into either a first data pool, a second data pool, or a third data pool. The processor may further execute instructions for computing normalized distance for the user device associated with each user of the first set of users, categorized in either of the first data pool, the second data pool, or the third data pool, from the closest geospatial point on the transfer path relative to the respective user devices associated with the first set of users. The processor further executes instructions for determining a probability of acceptance, of the dispatch request for a drop-off, by the user device associated with each user of the first set of users, categorized in either of the first data pool, the second data pool, or the third data pool, by processing the data of the user device associated with each user of the first set of users. If none of the user devices associated with the plurality of users are located within the predefined distance from the closest geospatial point on the transfer path relative to the respective user devices associated with the plurality of users, then the processor further executes instructions for identifying one or more user devices associated with a second set of users located within a predefined distance from any point on the vehicular path of a vehicle associated with the requestor device on route to the drop-off location. The processor further executes instructions for computing for each user device of the second set of users, the shortest geospatial distance of the respective user device to the vehicular path on route to the drop-off location. The processor further executes instructions for computing a score for the user device associated with each user of the first set of users based upon the normalized distance and the probability of acceptance of the user device associated with each user of the first set of users, or for the user device associated with each user of second set of users based upon the computed shortest geospatial distance. The processor may further execute instructions for transmitting, the dispatch request for a drop-off, to the user device associated with one or more users of the first set of users based upon the score of each user device associated with the first set of users, or to the user device associated with one or more users of the second set of users based upon the score of each user device associated with the second set of users. The processor may further execute instructions for receiving an acknowledgement message indicative of acceptance, of the dispatch request for a drop-off, by a user device associated with a user of the first set of users, or by a user device associated with a user of the second set of users. The processor may further execute instructions for notifying the requestor device with a confirmation message indicative of allocation, of the dispatch request for a drop-off, to the user device associated with the user of the first set of users, or to the user device associated with the user of the second set of users, based upon the receipt of the acknowledgement message. The processor may execute instructions for communicating the selected transfer path with the requestor device and the user device associated with the user of the first set of users, or an assisted embark location with the requestor device and the user device associated with the user of the second set of users, wherein the assisted embark location is indicative of a boarding point on the vehicular path for the user of the second set of users.

In yet another embodiment, a computer implemented method for real time delivery segmentation in logistics is disclosed. The method may include receiving, via a processor, data associated with each user of a plurality of user devices. The method may further include receiving, via the processor, a dispatch request for a pick-up from a requestor device. The method may further include recommending, via the processor, one or more transfer paths to the requestor device. Each transfer path is a polygonal chain of geospatial points. A transfer path from the one or more transfer paths may be selected by the requestor device or the processor. The method may further include identifying, via the processor, the user devices associated with a set of users, of the plurality of users, located within a predefined distance of the pick-up location. The method may further include processing, via the processor, the data associated with each user of the set of users based upon predefined parameters to categorize the set of users into either a first data pool, a second data pool, or a third data pool. The method may further include computing, via the processor, a normalized distance for the user device associated with each user of the set of users, categorized in either of the first data pool, the second data pool, or the third data pool, from the pick-up location. The method further includes determining, via the processor, a probability of acceptance, of the dispatch request for a pick-up, by the user device associated with each user of the set of users, categorized in either of the first data pool, the second data pool, or the third data pool, by processing the data of the user device associated with each user of the set of users. The method further includes computing, via the processor, a score for the user device associated with each user of the set of users based upon the normalized distance and the probability of acceptance of the user device associated with each user of the set of users. The method may further include transmitting, via the processor, the dispatch request for a pick-up to the user device associated with one or more users of the set of users based upon the score of each user device associated with the set of users. The method may further include receiving, via the processor, an acknowledgement message indicative of acceptance, of the dispatch request for a pick-up, by a user device associated with a user of the set of users. The method may further include notifying, via the processor, the requestor device with a confirmation message indicative of allocation, of the dispatch request for a pick-up, to the user device associated with the user of the set of users, based upon the receipt of the acknowledgement message. The method may further include communicating, via the processor, the selected transfer path with the requestor device and the user device associated with the user of the set of users.

In still another embodiment, a computer implemented method for real time delivery segmentation in logistics is disclosed. The method may include receiving, via a processor, data associated with each user of the plurality of user devices. The method may further include receiving, via the processor, a dispatch request for a drop-off from a requestor device. The method may include recommending, via the processor, one or more transfer paths to the requestor device. Each transfer path is a polygonal chain of geospatial points. A transfer path from the one or more transfer paths may be selected by the requestor device or the processor. The method may further include checking, via the processor, whether a user device associated with one or more users of the plurality of users is located within a predefined distance from the closest geospatial point on the transfer path relative to the respective user device associated with the one or more users of the plurality of users. If the user device associated with the one or more users of the plurality of users is located within the predefined distance from the closest geospatial point on the transfer path relative to the respective user device associated with the one or more users of the plurality of users, then the method may further include identifying, via the processor, the user devices associated with a first set of users, of the plurality of users, located within a predefined distance from the closest geospatial point on the transfer path relative to the respective user device associated with each user of the plurality of users. The method may further include processing, via the processor, the data associated with each user of the first set of users based upon predefined parameters to categorize the first set of users into either a first data pool, a second data pool, or a third data pool. The method may further include computing, via the processor, normalized distance for the user device associated with each user of the first set of users, categorized in either of the first data pool, the second data pool, or the third data pool, from the closest geospatial point on the transfer path relative to the respective user devices associated with the first set of users. The method further includes determining, via the processor, a probability of acceptance of the dispatch request for a drop-off by the user device associated with each user of the first set of users, categorized in either of the first data pool, the second data pool, or the third data pool, by processing the data of the user device associated with each user of the first set of users. If none of the user devices associated with the plurality of users are located within the predefined distance from the closest geospatial point on the transfer path relative to the respective user devices associated with the plurality of users, then the method may include identifying, via the processor, one or more user devices associated with a second set of users, located within a predefined distance from any point on the vehicular path of a vehicle associated with the requestor device on route to the drop-off location. The method may further include computing, via the processor, for each user device of the second set of users, the shortest geospatial distance of the respective user device to the vehicular path on route to the drop-off location. The method further includes computing, via the processor, a score for the user device associated with each user of the first set of users based upon the normalized distance and the probability of acceptance of the user device associated with each user of the set of users, or for the user device associated with each user of second set of users based upon the computed shortest geospatial distance. The method may further include transmitting, via the processor, the dispatch request for a drop-off to the user device associated with one or more users of the first set of users based upon the score of each user device associated with the first set of users, or to the user device associated with one or more users of the second set of users based upon the score of each user device associated with the second set of users. The method may further include receiving, via the processor, an acknowledgement message indicative of acceptance, of the dispatch request for a drop off, by a user device associated with a user of the first set of users, or by a user device associated with a user of the second set of users. The method may further include notifying, via the processor, the requestor device with a confirmation message indicative of allocation, of the dispatch request for a drop-off, to the user device associated with the user of the first set of users, or to the user device associated with the user of the second set of users, based upon the receipt of the acknowledgement message. The method may further include communicating, via the processor, the selected transfer path with the requestor device and the user device associated with the user of the first set of users, or an assisted embark location with the requestor device and the user device associated with the user of the second set of users, wherein the assisted embark location is indicative of a boarding point on the vehicular path for the user of the second set of users.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of a computer implemented system 101 for real time delivery segmentation in logistics, in accordance with an embodiment of the present subject matter.

FIG. 2 illustrates the system 101 and components of the system 101, in accordance with an embodiment of the present disclosure.

FIG. 3A and FIG. 3B illustrates a dispatch facilitated by the system 101, in accordance with an exemplary embodiment of the present disclosure.

FIG. 4A, FIG. 4B and FIG. 4C illustrate flow chart depicting a dispatch algorithm executed by the system 101 for facilitating a continuous and staggered dispatch for real time delivery segmentation in logistics, in accordance with an embodiment of the present disclosure.

FIG. 5 illustrates an assisted drop-off facility of the system 101, in accordance with an embodiment of the present disclosure.

FIG. 6 illustrates a dispatch request directly assigned to one of reserved set of user devices by the system 101, in accordance with an embodiment of the present disclosure.

FIG. 7A and FIG. 7B illustrate a method 700 implemented by the system 101 for real time delivery segmentation in logistics for dispatch request for a pick-up, in accordance with an embodiment of the present disclosure.

FIG. 8A, FIG. 8B, FIG. 8C and FIG. 8D illustrate a method 700 implemented by the system 101 for real time delivery segmentation in logistics for dispatch request for a drop-off, in accordance with an embodiment of the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated but is to be accorded the widest scope consistent with the principles and features described herein.

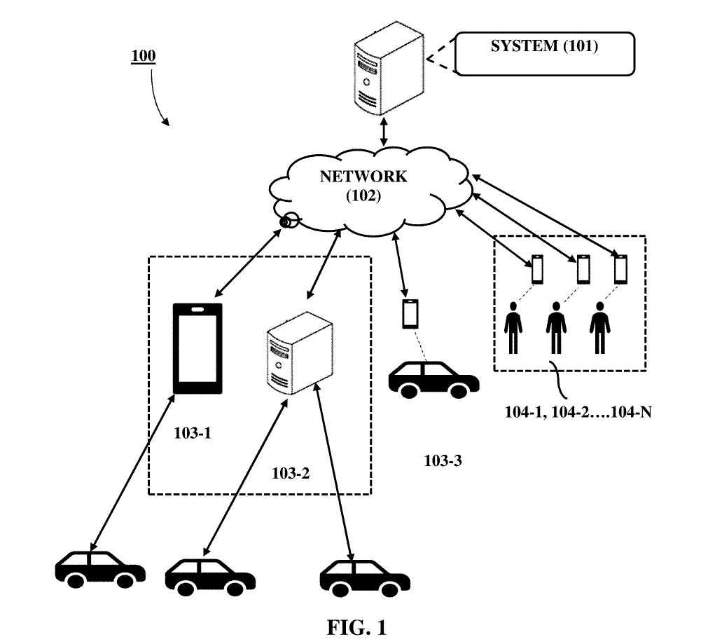

Referring to FIG. 1, a network implementation 100 of a system 101 for real time delivery segmentation in logistics is illustrated, in accordance with an embodiment of the present subject matter. Although the present subject matter is explained considering that the system 101 is implemented on a server, it may be understood that the system 101 may also be implemented in a variety of computing systems, such as a laptop computer, a desktop computer, a notebook, a workstation, a mainframe computer, a server, a network server, and the like. The system 101 may be communicatively coupled with a plurality of requestor devices 103-1, 103-2 . . . 103-N, hereinafter referred as requestor devices 103 or a requestor device 103 interchangeably. Each of the requestor device 103 may have one or more vehicles associated with the said requestor device 103. In one embodiment, the requestor device 103 may be a portable device (e.g. a portable computer, a personal digital assistant, a handheld device, or a workstation) belonging to a driver or a passenger of a vehicle or any other user, remotely positioned from the system 101, having an associated vehicle. In another embodiment, the requestor device 103 may be a Vehicle Infotainment System embedded within a vehicle. In yet another embodiment, the requestor device 103 may be an Internet of Things (IoT) device communicatively coupled with a vehicle. In still another embodiment, the requestor device 103 may be a computing platform selected from one of an on-demand platform, an ecommerce platform, a web portal, or a vehicle fleet management server, a cloud server, and the like.

In one embodiment, as shown in FIG. 1, the system 101 may be accessed by multiple users through one or more user devices 104-1, 104-2 . . . 104-N collectively referred to as user devices 104 or a user device 104 hereinafter, or applications residing on the said user devices 104. Examples of the user devices 104 may include, but are not limited to, a portable computer, a personal digital assistant, a handheld device, and a workstation. The requestor devices 103 and the user devices 104 are communicatively coupled to the system 101 through a network 102.

In one implementation, the network 102 may be a wireless network, a wired network or a combination thereof. The network 102 can be accessed by the user device 104 using wired or wireless network connectivity means including updated communications technology. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

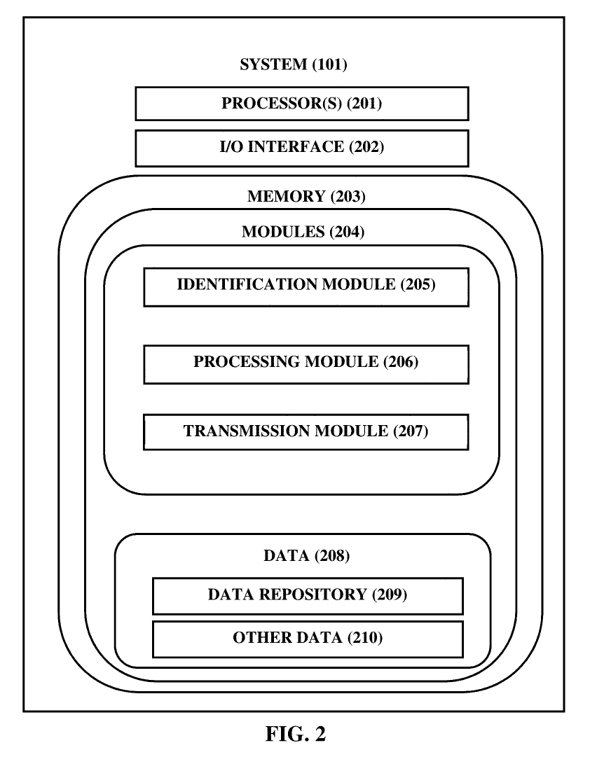

Now referring to FIG. 2, components of the system 101 are illustrated, in accordance with an embodiment of the present subject matter. The system 101 may comprise at least one processor 201, an input/output (I/O) interface 202, a memory 203, modules 204 and data 208. In one embodiment, the processor 201 may be configured to fetch and execute computer-readable instructions stored in the memory 203.

In one embodiment, the I/O interface 202 may include a variety of software and hardware interfaces, for example, a web interface, a graphical user interface, and the like. The I/O interface 202 may allow the system 101 to interact with the user devices 104. Further, the I/O interface 202 may enable the user device 104 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting to another server.

In an implementation, the memory 203 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 203 may include modules 204 and data 208.

The modules 204 may include routines, programs, objects, components, data structures, etc., which perform particular tasks, functions or implement particular abstract data types. In one implementation, the modules 204 may include an identification module 205, a processing module 206, a transmission module 207 and other modules (not shown in figure). The other modules may include programs or coded instructions that supplement applications and functions of the user device.

In one embodiment, the data 208 may include a data repository 209 and other data 210. In one exemplary embodiment, the repository 209 may be configured to store data processed, received, and generated by one or more of the modules 204. The other data 210 may include data generated as a result of the execution of one or more modules.

In one implementation, a user of the user device 104 may use the user device 104 to register with the system 101 via I/O interface 202. In one embodiment, the user may use an application installed over the user device 104 in order to register with the system 101. In one embodiment, the user may register with the system 101 based upon various registration techniques/methodologies prevalent and known in the existing art. The system 101 may enable the real time delivery segmentation in logistics, the details of which are hereinafter explained referring to FIGS. 1-3(b).

In one embodiment, the system 101 may receive data associated with each user of a plurality of user devices 104. The data associated with each user may be received from the respective user device 104 of the plurality of user devices 104. The system 101 may store the data received in to the data repository 209.

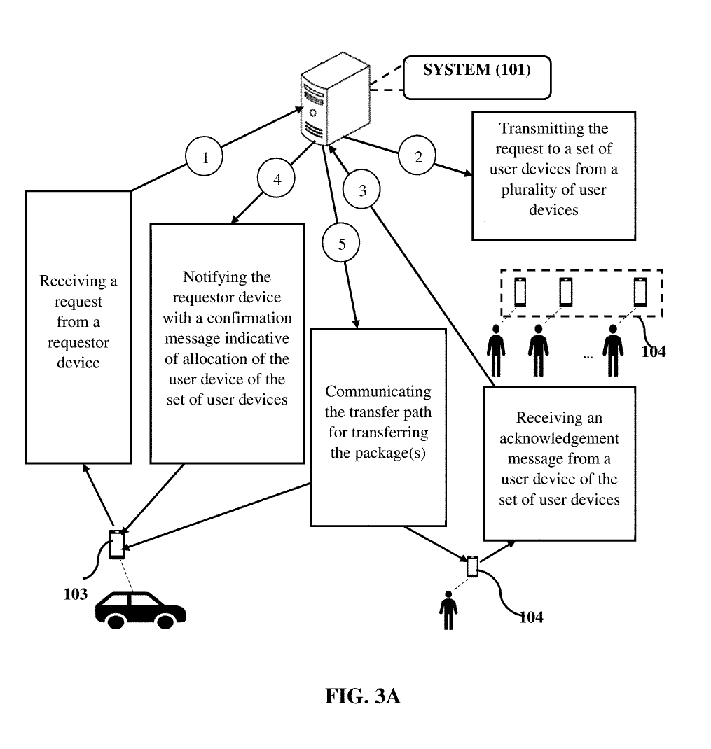

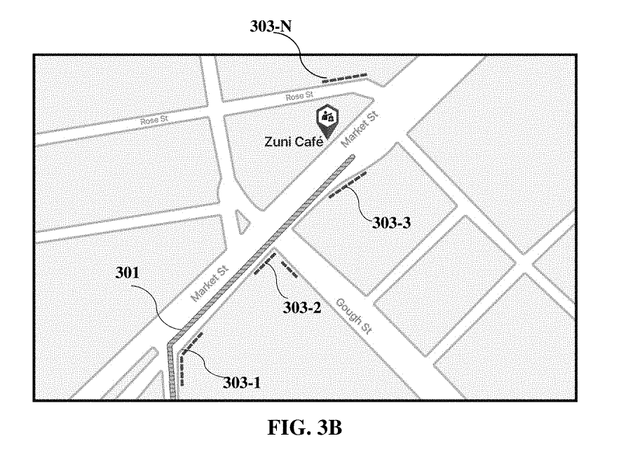

In one embodiment, as shown in FIG. 3A, the system 101 may receive a dispatch request for a pick-up/drop-off from the requestor device 103. In one embodiment, the requestor device 103 may belong to a driver of a vehicle, or a passenger of a vehicle, or any other user, remotely positioned from the system 101, having an associated vehicle. In another embodiment, the requestor device 103 may be a Vehicle Infotainment System embedded within a vehicle. In yet another embodiment, the requestor device 103 may be an Internet of things (IoT) device. In still another embodiment, the requestor device 103 may be a computing platform 103. In one embodiment, the computing platform 103 may be a vehicle fleet management server. In one exemplary embodiment, the vehicle fleet management server may be associated with an autonomous vehicle. For example, the vehicle fleet management server is a server capable of communicating and thereby controlling one or more autonomous vehicles. In another exemplary embodiment, the vehicle fleet management server may be associated with non-autonomous vehicles (i.e. manned or manually controlled vehicles). In another embodiment, the computing platform may be a third-party server or an on-demand platform capable of facilitating delivery of orders such as parcel, food, groceries, apparel and other physical goods on behalf of various warehouses, restaurants, grocery stores, retail outlets and other fulfillment centers respectively.

In one embodiment, the dispatch request for a pick-up may include one or more of geo-coordinates of a pick-up location, an order identifier (ID), and details of a delivery provider or order source. In another embodiment, the dispatch request for a drop-off may include one or more of geo-coordinates of a drop-off location, an order identifier (ID), details of delivery provider or order source, and assisted drop-off preference.

In one embodiment, in case the requestor device 103 is a device belonging to a user including a driver of a vehicle, or a passenger of a vehicle, or any other user with an associated vehicle, the system 101 may enable the said user of the requestor device 103 to enter a pick-up/drop-off location using a search component of a mapping provider service such as Google Maps or OpenStreetMap®. The resulting location such as geo-coordinates of the pick-up/drop-off location and a pick-up/drop-off location name may be stored in a memory of the requestor device 103. In another embodiment, the system 101 may enable the user of the requestor device 103 to tap on I/O interface or use any form of gesture to the pin object of the pick-up/drop-off location displayed on the map. The resulting location such as geo-coordinates of the pick-up/drop-off location and the pick-up/drop-off location name may be stored in the memory of the requestor device.

In one embodiment, in case the requestor device 103 is a device belonging to a user including a driver of a vehicle, or a passenger of a vehicle, or any other user having an associated vehicle, the system 101 may enable the user to enter an order source or enter a pre-selected order source. Thereafter, resulting data after entering the order source is stored in memory of the requestor device as the order source. In one embodiment, the order ID may comprise a string of characters, or a customer name. In another embodiment, the order ID may be a “Quick Response (QR)” code. In some embodiments, the order ID may be entered manually. The resulting data of the order ID is stored in the memory of the requestor device as a pick-up/drop-off order identifier.

In another embodiment, the system 101 may display a list of available dispatch requests for a pick-up/drop-off received from the external server (not shown in figure) to the user of the requestor device 103. In one embodiment, the system 101 may be communicatively coupled with an external server.

In one embodiment, a path with the shortest Estimated Time of Arrival (ETA) for the vehicle associated with the user of the requestor device 103 to the geo-coordinates of the pick-up/drop-off location may be suggested as the ‘default’ path on the user interface by the mapping server provider service. In one embodiment, the system 101 may enable the user of the requestor device 103 to select the other paths via tapping on the user interface, and further make the selected transfer path as default path. In one embodiment, the requestor device 103 may display a ‘suggested transfer paths for a pick-up/drop-off’ on the map. In one embodiment, the transfer path for a pick-up/drop-off may be a meeting point for the user of the requestor device 103, and the user of a user device 104 in order to transfer the package(s). In one exemplary embodiment, the requestor device 103 or the system 101 may suggest the transfer path for a pick-up/drop-off to the user of the requestor device 103 based on a multitude of factors including, but not limited to, the pick-up/drop-off location, side of the road that vehicles drive in a given country, real-time traffic details within predefined radius of the pick-up/drop-off location, third-party location data, and historical data of the requests (pick-up/drop-off) completed by the system, processed as inputs to a machine learning model or another form of proprietary technique known in the art. In one embodiment, the system 101 may enable the user of the requestor device 103 to accept the suggested transfer path for a pick-up/drop-off. In one embodiment, the requestor device 103 may enable the user of the said requestor device to send geo-coordinates of the pick-up/drop-off location, the pick-up/drop-off location name, the order source, the order identifier of a pick-up/drop-off and the dispatch request identifier (ID).

In another embodiment, in case the requestor device 103, issuing the dispatch request for a pick-up/drop-off, is either of the computing platform, the IoT device, or the Vehicle Infotainment System, the dispatch request for a pick-up/drop-off may include current geo-coordinates of the vehicle associated with the requestor device 103, an order identifier (ID), geo-coordinates of a pick-up/drop-off location and a pick-up/drop-off location name. In one embodiment, the dispatch request for a pick-up/drop-off may further include preferred transfer path of a pick-up/drop-off. The preferred transfer path of a pick-up/drop-off may be included within a payload of the dispatch request. In another embodiment, the system 101 may transmit a suggestion of a plurality of transfer paths for transferring package(s) for the dispatch request for a pick-up/drop-off to the requestor device 103. The requestor device 103 may select a transfer path for transferring package(s), for the dispatch request for a pick-up/drop-off, from the plurality of transfer paths suggested by the system 101. The system 101 may receive acceptance of the transfer path, for transferring the package(s) for the dispatch request for a pick-up/drop-off, from the requestor device 103. In one embodiment, the system 101 may suggest a plurality of transfer paths on the map, wherein each transfer path is a polygonal chain of geospatial points. The requestor device 103 may select the transfer path of the one or more transfer paths suggested to enable the transfer of the package(s). Alternatively, the requestor device 103 may ignore the transfer paths suggested by the system 101 and may select any other path on the map as the transfer path. It must be noted that the requestor device 103 may modify the transfer path at any stage/time before the dispatch request is complete. Further, in another embodiment, the user of the user device 104 selected for serving the dispatch request may be enabled to select and/or modify the transfer path at any time before the dispatch request is complete. In one embodiment, the system 101 may transmit acknowledgement to the requestor device 103, the said acknowledgement being indicative of acceptance of the transfer path by the requestor device 103. In one embodiment, the requestor device 103 may send a confirmation message to the system 101. In one embodiment, the confirmation message may comprise a pick-up/drop-off order identifier.

In one embodiment, in case the requestor device 103 is either the driver of the vehicle, the passenger of the vehicle, or any other user associated with the vehicle, the requestor device 103 may display a ‘suggested transfer path for a pick-up/drop-off’ on the map. Now referring to FIG. 3B, the suggested transfer path for the pick-up/drop-off on the map is illustrated, in accordance with the present subject matter. In one exemplary embodiment, the system 101 may display vehicular path 301 on route to the pick-up location. Further, the system 101 may display “vehicular path” to the drop-off location. In one embodiment, “vehicular path” may be indicated with the “thick colored line”. In one embodiment, the system 101 may display one or more transfer paths 303-1, 303-2, 303-3 . . . 303-N on the requestors' device 103 to transfer the package(s) from the user. In one embodiment, the one or more transfer paths may be indicated with “dotted colored lines” on the map. In one embodiment, the requestor device 103 or the system 101 may suggest a transfer path for a pick-up/drop-off to the user of the requestor device 103 based on a multitude of factors including, but not limited to, side of the road that vehicles drive in a given country, real-time traffic details in the area, and other factors. It is to be noted herein that the transfer path indicates the meeting point for the transfer of the package(s). It must be noted that the user of the requestor device 103 may modify the transfer path at any stage/time before the dispatch request is complete. In one embodiment, the system 101 or the requestor device 103 of the user may suggest a plurality of transfer paths on the map, wherein each transfer path is a polygonal chain of geospatial points. The user via the requestor device 103 may select a transfer path to indicate to the user of the user device 104 the transfer path for the transfer of the package(s). Alternatively, the user may ignore the transfer paths suggested by the system 101 and may select any other path on the map as the transfer path. In one embodiment, if the user ignores the transfer path suggested by the system 101, then the system 101 may select the transfer path by default.

Now again referring to FIG. 3A, in one embodiment, the system 101 may further refine the suggested transfer path for a pick-up/drop-off based on a machine learning model with the parameters being the historical data of the past dispatches fulfilled by the system 101 or use any other machine learning technique (known in the art) to further refine the suggested transfer paths for a pick-up/drop-off. In one embodiment, the system 101 may enable the user to accept the suggested transfer path for a pick-up/drop-off.

In one embodiment, the requestor device 103 may enable the user of the requestor device 103 to send geo-coordinates of the pick-up/drop-off location, the pick-up/drop-off location name, the order source, the geo-coordinates of the transfer path, the order identifier of a pick-up/drop-off and the dispatch request identifier (ID). The dispatch request may not include the geo-coordinates of the transfer path in case the user ignores the transfer path suggested by the system 101. It must be noted that the user may modify the transfer path at any stage/time before the dispatch request is complete. Further, in another embodiment, the user of the user device selected for serving the dispatch request may be enabled to select and/or modify the transfer path at any stage/time before the dispatch request is complete.

In an embodiment, in case the requestor device 103 is one of the computing platform, or the IoT device, or the Vehicle Infotainment System, the requestor device 103 may select a transfer path for transferring the package(s), from the plurality of transfer paths suggested by the system 101. The system 101 may receive acceptance of the transfer path for transferring the package(s), from the requestor device 103. In one embodiment, the system 101 may transmit an acknowledgement to the requestor device 103. In one embodiment, the requestor device 103 may send a confirmation message to the system 101. In one embodiment, the confirmation message may comprise a pick-up/drop-off order identifier. After the receipt of the dispatch request from the requestor device 103 as described above, the system 101 may select one of the plurality of users of the user devices 104 for facilitating the transfer of the package(s) at the transfer path based upon the pick-up/drop-off location geo-coordinates, and the transfer path (i.e. meeting point) geo-coordinates. The details of selecting one of the plurality of the users of the user devices 104 for facilitating the transfer of the package(s) are hereinafter explained as below.

In one embodiment, as shown in FIG. 2, the identification module 205 may enable the system 101 to identify the user devices 104 associated with a set of users, of the plurality of users, located within a predefined distance of the pick-up location. In case of drop-off, the system 101 may check whether a user device associated with one or more users of the plurality of users is located within a predefined distance from the closest geospatial point on the transfer path relative to the respective user device associated with the one or more users of the plurality of users. If the user device associated with the one or more users of the plurality of users is located within the predefined distance from the closest geospatial point on the transfer path relative to the respective user device associated with the one or more users of the plurality of users, then the identification module 205 may enable the system 101 to identify the user devices associated with a first set of users, of the plurality of users, located within the predefined distance from the closest geospatial point on the transfer path relative to the respective user device associated with each user of the plurality of users. The set of users may be the users located within the predefined distance of the pick-up location. The first set of users may be the users located within the predefined distance from the closest geospatial point on the transfer path relative to the respective user devices associated with the plurality of users. It must be noted herein that the system 101 may include multiple users located in different regions/area, or a town, or a city, or a state, or a country, and the like. Therefore, the system 101 may initially identify user devices 104 of few users of the multiple users those are within the proximity of the location from where the dispatch request associated with the pick-up/drop-off is to be fulfilled. Accordingly, the identification module 205 identifies the user devices associated with the set of users, from the plurality of users, that are located within the predefined distance (e.g. a few meters, etc.) from the pick-up location, or the user devices associated with the first set of users, from the plurality of users, that are located within the predefined distance from the closest geospatial point on the transfer path relative to the respective user devices associated with the plurality of users.

In one embodiment, after the identification of the user devices 104 of the set of users for the dispatch request for a pick-up, or the first set of users for the dispatch request for a drop-off, the processing module 206 (as shown in FIG. 2) may enable the system 101 to process the data associated with each user of the set of users of the user devices 104 for the dispatch request for a pick-up, or the data associated with each user of first set of users of the user devices 104 for the dispatch request for a drop-off. In one embodiment, the processing module 206 may categorize the set of users, along with their respective data, into either a first data pool, a second data pool, or a third data pool based upon the predefined parameters. In case of drop-off, the processing module 206 may categorize the first set of users, along with their respective data, into either a first data pool, a second data pool, or a third data pool based upon the predefined parameters. In one embodiment, the first data pool, the second data pool and the third pool may be categorically stored in the data repository 209. In one embodiment, the predefined parameters, enabling the categorization, may include, but not limited to, one or more of: distance of the user device of each user from the pick-up location or from the closest geospatial point on the transfer path relative to the respective user device, transportation mode (i.e. walking, cycling, or operating a SEGWAY® etc.), the current mode (i.e. current mode selected by the user may be actively online, or passively online etc.) selected by the user, the number of dispatches the user is currently engaged in, and the dispatch status of assigned dispatch request of the user. In case of the dispatch request for a pick-up, the dispatch status may include, but not limited to, “on the way to the pick-up location”, or “at the pick-up location”, or “on the way to the transfer path for the pick-up”, or “at the transfer path for the pick-up”. In case of the dispatch request for a drop-off, the status may include, but not limited to, “on the way to the transfer path for the drop-off”, or “at the transfer path for a drop-off”, or “on the way to the drop-off location”, or “at the drop-off location”. In case of an assisted drop-off (explained in detail in subsequent paragraphs), the dispatch status may include, but not limited to, “on the way to the assisted embark location”, or “at the assisted embark location”, or “in the vehicle”, or “on the way to a drop-off location”, or “at the drop-off location”. In one embodiment, the processing module 206 may derive these parameters for each user of the set of users (in case of the dispatch request for a pick-up), or the first set of users (in case of the dispatch request for a drop-off) based upon the data received for each user of the set of users (in case of the dispatch request for a pick-up), or the first set of users (in case of the dispatch request for a drop-off) by the system 101. Based upon the processing the data of each user of the set of users (in case of the dispatch request for a pick-up), or the first set of users (in case of the dispatch request for a drop-off), the processing module 206 categorizes each user (and/or user device associated with each user) of the set of users (in case of the dispatch request for a pick-up), or the first set of users (in case of the dispatch request for a drop-off) into one of the first data pool, the second data pool and the third data pool.

In one embodiment, the first data pool may include one or more user devices associated with the set of users (in case of the dispatch request for a pick-up) or the first of users (in case of the dispatch request for a drop-off) satisfying the following conditions:
Current mode selected by a user is “actively online” and the user device of the said user is geospatially present within a first predefined distance (e.g. 200 meters) from the pick-up location or from the closest geospatial point on the transfer path relative to the respective user device of the said user for a drop-off,
Have not already rejected the current dispatch request for a pick-up/drop-off received, and
Not assigned with the dispatch request for a pick-up/drop-off received.

In one embodiment, the second data pool may include one or more user devices associated with the set of users (in case of the dispatch request for a pick-up), or the first set of users (in case of the dispatch request for a drop-off) satisfying the following conditions:
Current mode selected by a user is “passively online” and the user device of the said user is geospatially present within a second predefined distance (e.g. 32 meters) from the pick-up location or from the closest geospatial point on the transfer path relative to the said user device for a drop-off,
Have not already rejected the current dispatch request for a pick-up/drop-off received, and
Not assigned with the dispatch request for a pick-up/drop-off received.

In one embodiment, the third data pool may include one or more user devices associated with the set of users (in case of the dispatch request for a pick-up), or the first set of users (in case of the dispatch request for a drop-off) satisfying the following conditions:
Currently assigned with one or more other dispatch requests, wherein none of the currently assigned other dispatch requests have their associated vehicles with Estimated Time of Arrival (ETA) from the transfer path as less than a predefined time interval (e.g. 5 minutes) from the vehicle's associated with the requestor device, Estimated Time of Arrival (ETA) (corresponding to the current dispatch request for a pick-up/drop-off) from the transfer path; and the user device is within a predefined distance (16 meters) from pick-up location or from the closest geospatial point on the transfer path relative to the said respective user device, and
Have not already rejected the current dispatch request for a pick-up/drop-off received, and
Not assigned with the dispatch request for a pick-up/drop-off received.

Hereinafter, the first data pool, the second data pool, and the third data pool are referred as “actively online user devices”, “passively online user devices”, and “partially engaged user devices” respectively.

In one embodiment, after the categorization of each user devices associated with the set of users (in case of the dispatch request for a pick-up), or the first set of users (in case of the dispatch request for a drop-off) into one of the actively online user devices, the passively online user devices, and partially engaged user devices, the processing module 206 may be configured to compute normalized distance from the pick-up location for a pick-up, or from the closest geospatial point on the transfer path relative to the respective user device for a drop-off for the user devices categorized as the actively online user devices, the passively online user devices, and the partially engaged user devices. In one embodiment, the processing module 206 may compute the normalized distance for the user devices categorized as the actively online user devices based upon a predefined multiplying factor which is dependent on the transportation mode of each user device categorized as the actively online user device. In one embodiment, the predefined multiplying factor for a user device categorized as an actively online user device and with the transportation mode as “walking” is higher as compared to another user device categorized as an actively online user device with transportation mode as “cycling”. In one exemplary embodiment, if the user is walking or cycling, the predefined multiplying factor corresponding to the user device of the user may have a value of 0.8 and 0.6 respectively. In this exemplary embodiment, the processing module 206 may compute the normalized distance as the multiplication of actual distance from the pick-up location for a pick-up, or from the closest geospatial point on the transfer path relative to the respective user device of the user for a drop-off and the predefined multiplying factor. Therefore, in one example, if the calculated distance from the pick-up location for a pick-up, or the closest geospatial point on the transfer path relative to the respective user device for a drop-off is 100 meters, the normalized distance for the user device having the transportation mode as “walking” or “cycling” is 80 meters and 60 meters respectively. In another embodiment, the normalized distance for the user devices categorized in the passively online user devices, and the partially engaged user devices may be the distance (i.e. the actual distance) from the pick-up or from the closest geospatial point on the transfer path relative to the respective user device.

In one embodiment, the processing module 206 is further configured to determine a probability of acceptance, of the dispatch request for a pick-up or a drop-off, by the user device associated with each user of the set of users (in case of the dispatch request for a pick-up), or the first set of users (in case of the dispatch request for a drop-off) categorized in either of the actively online user devices, the passively online user devices, or the partially engaged user devices. In one embodiment, the probability of acceptance may be represented by a confidence level within a numerical range of ‘0’ and ‘1’. In one embodiment, the probability of acceptance may be determined by processing of the data associated with each user of the set of users (in case of the dispatch request for a pick-up), or the first set of users (in case of the dispatch request for a drop-off) based upon a plurality of predefined factors. In one embodiment, the plurality of predefined factors may include, but not limited to, one or more of distance of the user device of each the user from the pick-up location or from the closest geospatial point on the transfer path relative to the respective user device for a drop-off, shortest geospatial distance to the vehicular path on route to the drop-off location for assisted drop-offs, transportation mode (i.e. walking, cycling, or operating a SEGWAY® etc.), preferred geofences for the pick-up/drop-off location (e.g. predefined area/region within a town/city, etc.), preferred drop-off locations for assisted drop-offs, preferred geofences for the transfer path for a pick-up/drop-off, current geo-coordinates of the user, time of the day, the current mode (i.e. actively online, or passively online, or partially engaged etc.) of the user, the time series of the geo-coordinates in a past predefined time period (e.g. 5 minutes) of the user, current status of the assigned dispatch requests of the user. As described above, the current mode may be either one of the modes comprising actively online, passively online and partially engaged. In one embodiment, the system 101 may enable the user to set the current mode via the respective user device. In one embodiment, the system 101, by default, may set the current mode of the user of the user device as “passively online”. In the passively online mode, the said user may set preferred geo-fences, preferred destination location in case of assisted drop-offs, and preferred time ranges for acceptance of dispatch requests for a pick-up/drop-off. It must be noted herein that the preferred geo-fences indicate a predefined area/region within which the respective user would be available for accepting the dispatch request for a pick-up/drop-off. Further, it must be noted that the preferred time ranges indicate preferred time ranges associated with days of the week during which the respective user would be available for accepting dispatch requests for a pick-up/drop-off.

In one embodiment, after the determination of the probability of acceptance, the processing module 206 is configured to compute a score for the user device associated with each user of the set of users (in case of the dispatch request for a pick-up) or the first set of users (in case of the dispatch request for a drop-off) based upon the normalized distance and the probability of acceptance of the user device associated with each user of the set of users (in case of the dispatch request for a pick-up) or the first set of users (in case of the dispatch request for a drop-off). In one embodiment, the score for the user device associated with each user of the set of users (in case of the dispatch request for a pick-up) or the first set of users (in case of the dispatch request for a drop-off) may be computed using the predefined formula below:

[Normalized distance×k (1−Probability of acceptance)], wherein “k” is a predefined constant.

Further, the processing module 206 may be configured to perform sorting of the list of user devices (belonging to the set of users (in case of the dispatch request for a pick-up) or to the first set of users (in case of the dispatch request for a drop-off)) in ascending order based upon the score computed for the user device of each user.

It must be noted herein that the processing module 206 may iteratively perform the aforementioned tasks/steps based upon current location of the user device associated with each user of the set of users (in case of the dispatch request for a pick-up) or the first set of users (in case of the dispatch request for a drop-off). The current location of the user device may be continuously updated in real time. Therefore, the processing module 206 may iteratively perform the aforementioned tasks/steps of categorizing the set of users (in case of the dispatch request for a pick-up) or the first set of users (in case of the dispatch request for a drop-off), computing the normalized distance, determining the probability of acceptance, and computing a score from the instance of receipt of the dispatch request for a pick-up/drop-off until the said dispatch request for a pick-up/drop-off is accepted by at least one user of the set of users (in case of the dispatch request for a pick-up) associated with the set of user devices 104 or at least one user of the first set of users (in case of the dispatch request for a drop-off) associated with the first set of user devices 104. In one embodiment, if none of the user devices associated with the plurality of users is located within a predefined distance from the closest point on the transfer path relative to the respective user devices associated with the plurality of users, the system 101 may implement an assisted drop-off. In case of the assisted drop-off, the identification module 206 of the system 101 may identify one or more user devices associated with a second set of users, located within a predefined distance from any point on the vehicular path of the vehicle associated with the requestor device 103 on route to the drop-off location. The processing module 206 may compute for each user device of the second set of users, the shortest geospatial distance of the respective user device to the vehicular path on route to the drop-off location.

In one embodiment, the transmission module 207 may be configured to transmit the dispatch request for a pick-up to the user device associated with one or more users of the set of users based upon the score of each user device associated with the set of users. In one embodiment, the transmission module 207 may be configured to transmit the dispatch request for a drop-off to the user device associated with one or more users of the first set of users based upon the score of each user device associated with the first set of users, or to the user device associated with one or more users of the second set of users based upon the score of each user device associated with the second set of users. In one embodiment, the transmission module 207 may perform “staggering” of the dispatch request for a pick-up to subsequent user device associated with one or more users in the sorted list, when a preceding user device corresponding to the said user device in the sorted list fails to accept the dispatch request for a pick-up before the expiry of a predefined threshold duration allocated for acceptance of the dispatch request for a pick-up. In one embodiment, the transmission module 207 may perform “staggering” of the dispatch request for a drop-off to subsequent user device associated with one or more users in the sorted list, when a preceding user device corresponding to the said user device in the sorted list fails to accept the dispatch request for a drop-off before the expiry of a predefined threshold duration allocated for acceptance of the dispatch request for a drop-off. In case of an assisted drop-off, the transmission module 207 may perform “staggering” of the dispatch request for a drop-off to subsequent user device associated with one or more users of the second set of users based upon the score of each user device associated with the second set of users, when a preceding user device corresponding to said user device fails to accept the dispatch request for a drop-off before the expiry of a predefined threshold duration allocated for acceptance of the dispatch request for a drop-off. In one embodiment, the user of the user device is selected using a unique identifier (ID) generated for the dispatch request, also referred hereinafter as “dispatch request ID”, geo-coordinates of the pick-up/drop-off location, pick-up/drop-off location name, geo-coordinates of the transfer path for a pick-up/drop-off. In one embodiment, the user of the user device may act on the dispatch request for a pick-up/drop-off within the predefined threshold duration (e. g: 30 seconds). In one embodiment, the user device may send acceptance of the dispatch request for a pick-up/drop-off to the system 101 by identifying it with the dispatch request ID. In one embodiment, the user device may send rejection of the dispatch request for a pick-up/drop-off to the system 101 by identifying it with the dispatch request ID. In one embodiment, the system 101 may repeat the aforementioned methodology to locate another user for dispatch request for a pick-up/drop-off, if the system 101 fails to receive any response from the user within the predefined threshold duration (e.g. 30 second). In one embodiment, the system 101 may allocate the dispatch request for a pick-up/drop-off to the user who responds first to the dispatch request for a pick-up/drop-off.

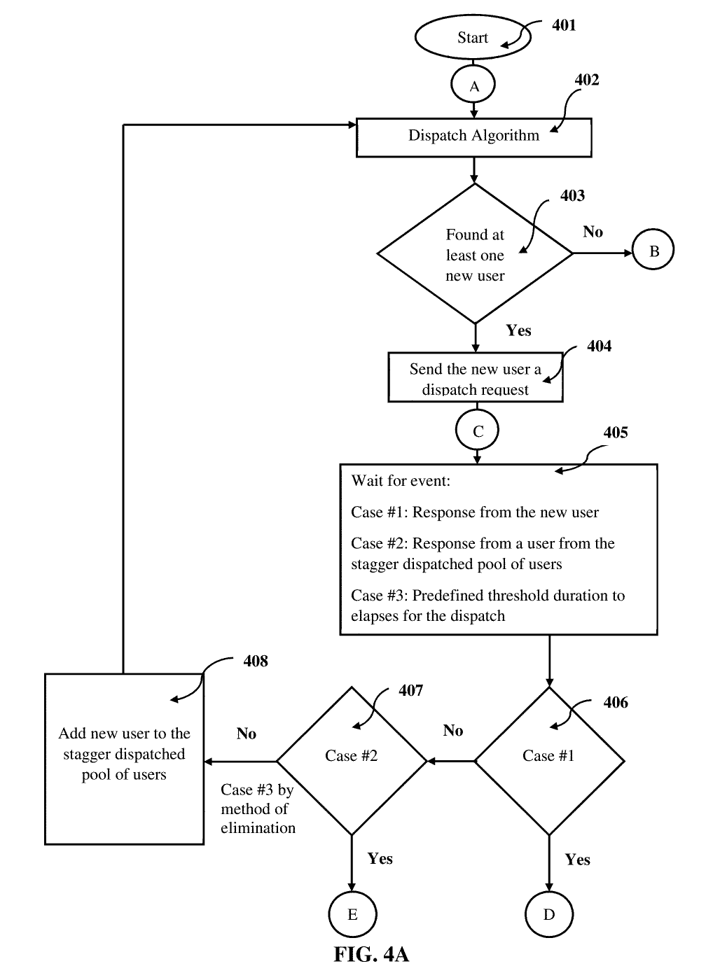

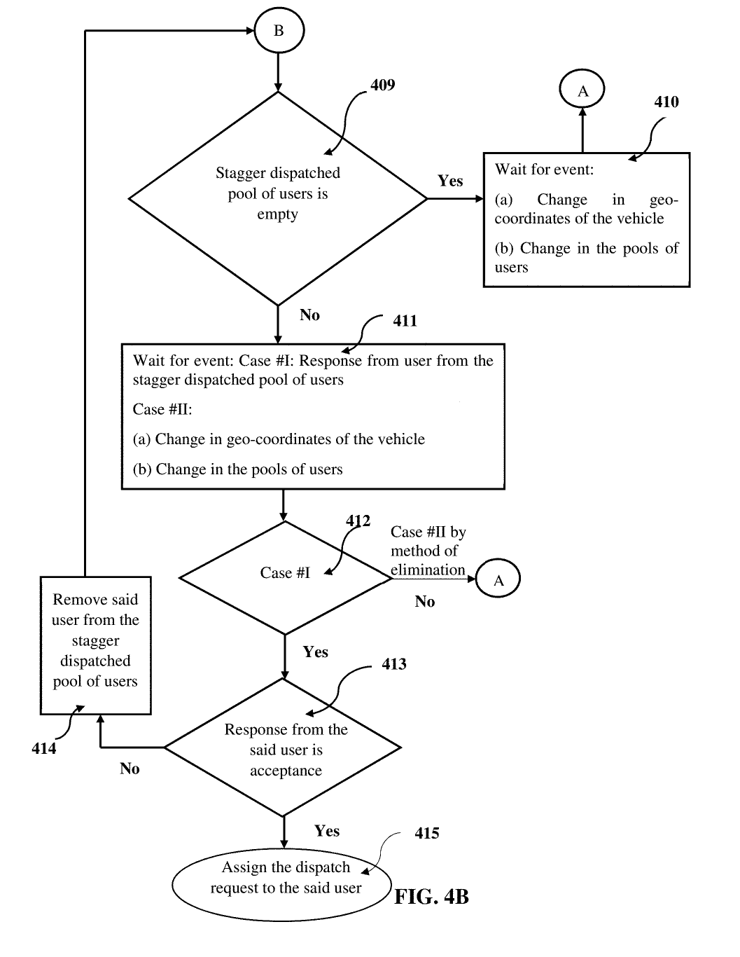

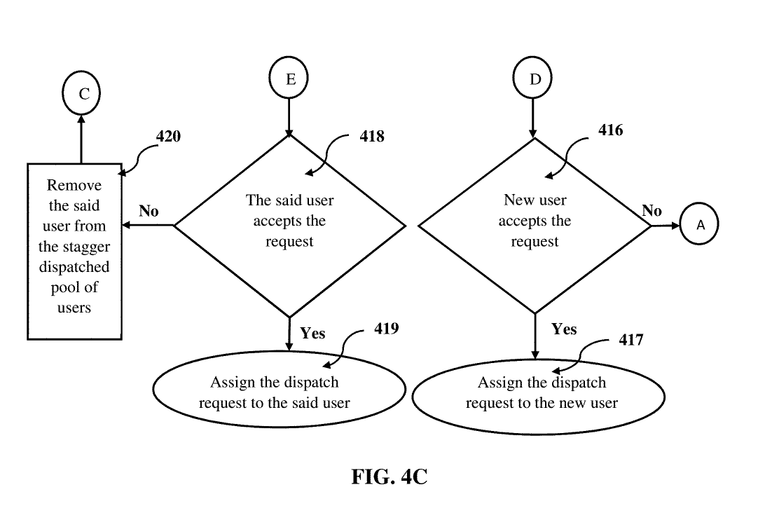

FIG. 4A, FIG. 4B and FIG. 4B illustrates a flow chart depicting a dispatch algorithm executed by the system 101 for facilitating a continuous and staggered dispatch for real time delivery segmentation in logistics, in accordance with the present subject matter. It must be noted herein that steps 402-420 depicted in FIG. 4A, FIG. 4B and FIG. 4C represents a dispatch algorithm being continuously executed until a user of the set of users (in case of the dispatch request for a pick-up) or a user of the first set of users (in case of the dispatch request for a drop-off) or a user of the second set of users (in case of an assisted drop-off) is identified for fulfilling a dispatch request received from the requestor device 103. At step 401, the system 101 may initiate the step-wise process of the “staggered dispatch”. At step 402, the system 101 may execute instructions for initiating the dispatch algorithm in order to find a user from the set of users (in case of the dispatch request for a pick-up), or a user from the first set of users (in case of the dispatch request for a drop-off), or a user from the second set of users (in case of an assisted drop-off), as the case may be, for staggered dispatch. In one embodiment, the set of users (in case of the dispatch request for a pick-up), or the first set of users (in case of the dispatch request for a drop-off) may comprise the users categorized into either a first data pool, a second data pool, or a third data pool. The second set of users represents users having their user devices not present within a predefined distance from the closest point on the transfer path relative to the respective user device for drop-off, but are present within a predefined distance from any point on the vehicular path on route to the drop-off location. In one embodiment, the system 101 may maintain a stagger dispatched pool of users for the allocation of the said dispatch request. In one embodiment, the stagger dispatched pool of users may include one or more users of the set of users (in case of the dispatch request for a pick-up), or the first set of users (in case of the dispatch request for a drop-off), or the second set of users (in case of an assisted drop-off) who have been already transmitted the said dispatch request but have not responded to the said dispatch request within a predefined threshold duration. At step 403, the system 101 may execute instructions to find a new user from the set of users (in case of the dispatch request for a pick-up), or the first set of users (in case of the dispatch request for a drop-off), or the second set of users (in case of an assisted drop-off) to fulfill the dispatch request issued by the requestor device 103. If the system 101 finds the new user from the set of users to fulfill the dispatch request issued by the requestor device, then at step 404, the system 101 may send the dispatch request to the new user from the set of users. Then, at step 405, the system 101 may wait for an event from a group of events to occur. In one embodiment, the group of events may comprise of case 1, case 2, and case 3. In one embodiment, case 1 represents the occurrence of an event indicating a response received from the new user. In another embodiment, case 2 represents occurrence of an event indicating a response received from one of the users from the stagger dispatched pool of users. In yet another embodiment, case 3 represents occurrence of an event indicating the predefined threshold duration to respond to the dispatch request by the new user elapsed.

In one embodiment, if it is determined at step 405 that event corresponding to case 1 is occurred, then at step 406, the system 101 proceeds to step 416. It must be noted herein that the occurrence of event corresponding to case 1 indicates that the new user has responded to the dispatch request before the elapse of the threshold duration set for the new user to respond to the dispatch request. At step 416, the system 101 may check, whether the dispatch request is accepted or rejected by the new user. If the new user accepts the dispatch request, then at step 417, the system 101 may assign said dispatch request to the new user. If the new user rejects the dispatch request, then system 101 may proceed back to step 402 in order to execute the dispatch algorithm to identify a subsequent new user for the said dispatch request.

In another embodiment, if it is determined at step 405 that event corresponding to case 2 has occurred, then at step 407, the system 101 proceeds to step 418. It must be noted herein that the occurrence of the event corresponding to case 2 indicates that a user of the stagger dispatched pool of users has responded to the said dispatch request. At step 418, the system 101 may check whether the dispatch request is accepted or rejected by the said user of the stagger dispatched pool of users. If the said user of the stagger dispatched pool of users accepts the said dispatch request, then at step 419, the system 101 may assign the said dispatch request to the said user. If the said user of the stagger dispatched pool of users rejects the said dispatch request, then at step 420, the system 101 may remove the said user from the pool of stagger dispatched users and proceed back to step 405 of the dispatch algorithm.

In yet another embodiment, if it is determined at step 405 that event corresponding to case 3 has occurred (as determined by method of elimination of case 1 and case 2), then the system 101 proceeds to step 408. It must be noted herein that the occurrence of event corresponding to case 3 indicates that the threshold duration set for the new user to respond the dispatch request has elapsed, and neither the new user has responded the dispatch request, nor any user from the stagger dispatched pool of users has responded to the said dispatch request before the elapse of threshold duration set for the new user to respond the dispatch request. At step 408, the system 101 may add the new user into the stagger dispatched pool of users and proceed back to step 402 in order to re-execute the dispatch algorithm to identify a subsequent new user for the said dispatch request.

Now, referring back to step 403, if the system 101 fails to find the new user (or any subsequent new user) to fulfill the said dispatch request, then at step 409, the system 101 may check whether the stagger dispatched pool of users is empty. In one embodiment, if the system 101 finds the stagger dispatched pool of users is empty, then at step 410, the system 101 may wait for an event from a group of events to occur, wherein the group of events may include a first event indicating a change in geo-coordinates of the vehicle associated with the requestor device 103 and a second event indicating a change in the three data pools of the set of users (in case of the dispatch request for a pick-up), or first set of users (in case of the dispatch request for a drop-off), or the second set of users (in case of an assisted drop-off). After the occurrence of any of these events, the system may proceed back to step 402 in order to re-execute the dispatch algorithm to identify a subsequent new user for the said dispatch request.

In another embodiment, if the system 101 finds the stagger dispatched pool of users is not empty, and then at step 411, the system 101 may wait for an event to occur from a group of events. In one embodiment, the group of events may comprise case I and case II. In one embodiment, case I represents occurrence of an event indicating a response received from a user from the stagger dispatched pool of users. In yet another embodiment, case II represents occurrence of either case II (a) or case II (b), wherein case I (a) indicates a change in geo-coordinates of the vehicle associated with the requestor device 103, and case II (b) indicates a change in the three data pools of the set of users (in case of the dispatch request for a pick-up), or the first set of users (in case of the dispatch request for a drop-off), or the second set of users (in case of an assisted drop-off).

In one embodiment, if it is determined at step 411 that the event corresponding to case I has occurred, then at step 412 the system 101 proceeds to step 413. At step 413, the system 101 may check, whether the dispatch request is accepted or rejected by the said user of the stagger dispatched pool of users. If the said user of the stagger dispatched pool of users accepts the dispatch request, then at step 415, the system 101 may assign the dispatch request to the said user of the stagger dispatched pool of users. If the said user of the stagger dispatched pool of users rejects the dispatch request, then at step 414, the system 101 may remove the said user from the pool of stagger dispatched users and proceeds back to step 409.

In another embodiment, if it is determined at step 411 that the event corresponding to case II has occurred (as determined by method of elimination of case I), wherein the event II (a) event indicates change in geo-coordinates of the vehicle associated with the requestor device 103 and the event II (b) indicates change in the three data pools of the set of users (in case of the dispatch request for a pick-up), or the first set of users (in case of the dispatch request for a drop-off), or the second set of users (in case of an assisted drop-off). After the occurrence of these events including event II (a) and event II (b), the system 101 may proceed back to step 402 in order to re-execute the dispatch algorithm to identify a subsequent new user for the said dispatch request.

Therefore, based upon continuous and staggered dispatch algorithm being executed by the system 101, the system 101 may select the user of the set of users (in case of the dispatch request for a pick-up), or the user of the first set of users (in case of the dispatch request for a drop-off), or the user of second set of users (in case of an assisted drop-off) who responds and accepts the dispatch request first in order to assign the said dispatch request to the said user.

In one embodiment, the system 101 may receive an acknowledgement message indicative of acceptance, of the dispatch request for a pick-up, by a user device associated with a user of the set of users. In one embodiment, the system 101 may receive an acknowledgement message indicative of acceptance, of the dispatch request for a drop-off, by a user device associated with a user of the first set of users. In case of an assisted drop-off, the system 101 may receive an acknowledgement message indicative of acceptance, of the dispatch request for a drop-off, by a user device associated with a user of the second set of users.

In one embodiment, the transmission module 207 may be configured to notify the requestor device 103 with a confirmation message indicative of allocation, of the dispatch request for a pick-up, to the user device associated with the user of the set of users, based upon the receipt of the acknowledgement message. In one embodiment, the transmission module 207 may be configured to notify the requestor device 103 with a confirmation message indicative of allocation, of the dispatch request for a drop-off, to the user device associated with the user of the first set of users, or to the user device associated with the user of the second set of users, based upon the receipt of the acknowledgement message. The system 101 may transmit additional data of the user including, but not limited to, user identifiable information, transportation mode (walking, cycling, etc.), current location, dispatch status and other details to the requestor device 103.

In one embodiment, the transmission module 207 may be configured to communicate the selected transfer path to the requestor device and the user device of the user from the first set of users. In another embodiment, the transmission module 207 may be configured to communicate the assisted embark location to the requestor device and the user device of the user from the second set of users. In one embodiment, the system 101 may be configured to update status of the dispatch and accordingly provide status updates to the requestor device 103 and the user device 104. In one embodiment, the system 101 may generate periodic status update using the geo-coordinates obtained through a GPS tracking module of the requestor device 103 or of the vehicle associated with the requestor device 103. In one embodiment, the system 101 may transmit periodic status updates received from the requestor device 103 to the user device 104. In one embodiment, the user device 104 may send the periodic status updates in context of the dispatch request for a pick-up/drop-off. In one embodiment, the system 101 may generate periodic status update using the geo-coordinates obtained from a GPS tracking module of the user device 104. The system 101 may transmit periodic status updates received from the user device 104 to the requestor device 103. The user of the user device 104 then picks up the package(s) from the pick-up location or drops off the package(s) at drop-off location as identified by either or a combination of the geo-coordinates of the pick-up/drop-off location and name of the pick-up/drop-off location respectively.

In case of the dispatch for a pick-up, the default status of the user may be “travelling to the pick-up location”. Once the user of the user device 104 reaches the pick-up location, the system 101 may enable the user, via the user device 104 of the said user, to change status to “waiting at pick-up location”. After receiving the transfer path from the system 101, the user may change the status to “travelling to the transfer path”. Finally, for the pick-up, the system 101 may enable the user to mark the pick-up as complete after transfer of the package(s) to the vehicle associated with the requestor device 103 at the transfer path.

In case of the dispatch for a drop-off, the default status of the user of the user device 104 may be “travelling to the transfer path”. Once the user reaches the transfer path for drop-off, the system 101 may enable the user, via the user device 104, to change status to “waiting at transfer path for drop-off”. Finally, after collecting the package(s) from the vehicle associated with the requestor device 103 at the transfer path for drop-off, the user of the user device 104 may change the status to “travelling to the drop-off location”. The system 101 may enable the user of the user device 104 to mark the drop-off as complete after proceeding to drop off the package(s) at the drop-off location. In case of an assisted drop-off, the default status of the user of the user device 104 may be, “on the way to the assisted embark location”. The system 101 may enable the user of the user device 104 to change the status to “at the assisted embark location” when the user of the user device 104 reaches to the assisted embark location. The system 101 may enable the user of the user device 104 to change the status to “on route to the drop-off location”, when the user of the device 104 boards the vehicle. The system 101 may enable the user of the user device 104 to change the status to “at the drop-off location” when the user of the user device 104 reaches the drop-off location.

In case the requestor device 103, issuing the dispatch request, is the vehicle fleet management server 103 associated with an autonomous vehicle, the autonomous vehicle may comprise a device external to the autonomous vehicle which enables the user of the device 104 to enter a pin number in order to open the vehicle (doors, windows, trunk, and/or bonnet). In one embodiment, the device external to the autonomous vehicle may comprise user interface to enter the pin number. In one exemplary embodiment, the user interface may be a keypad of the device or a touch screen of the device. In one embodiment, the system 101 may receive the pin number from the vehicle fleet management server. In one embodiment, the system 101 may transmit the pin number to the user device. In another embodiment, the vehicle fleet management server 103 may be communicatively coupled with the device associated with the vehicle. The system 101 may receive a request from the user of the user device 104 to open one or more of the vehicle's openings. The system 101 may transmit the request to the vehicle fleet management server 103 to open one or more of the vehicle's openings. The vehicle fleet management server 103 may transmit the request to the device associated with the vehicle to open the vehicle's openings. The user of the user device 104 may transfer package(s) into the autonomous vehicle or transfer the package(s) out from the autonomous vehicle based upon the dispatch request being a dispatch request for a pick-up or a dispatch request for a drop off respectively.

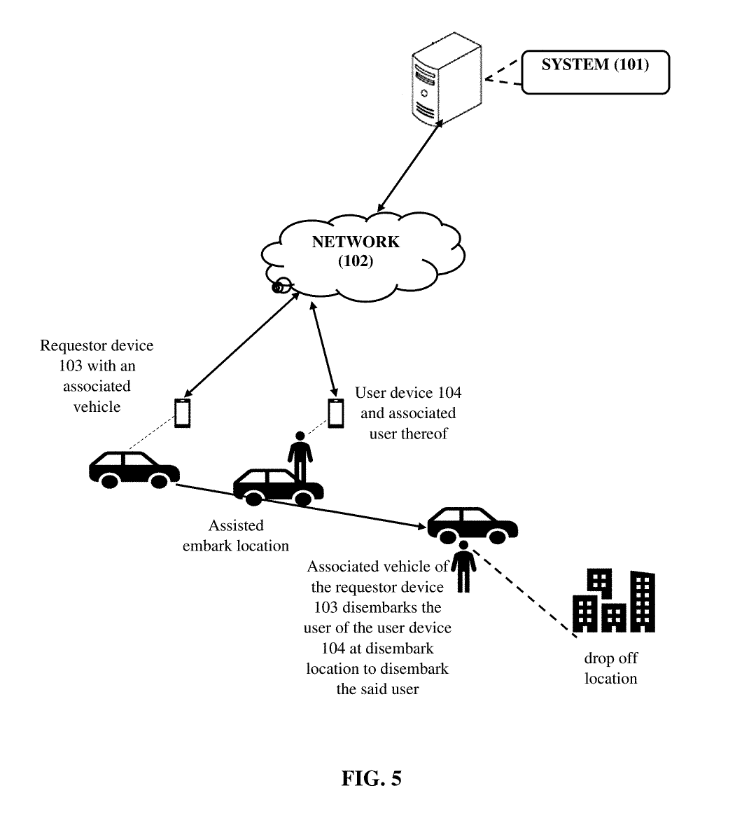

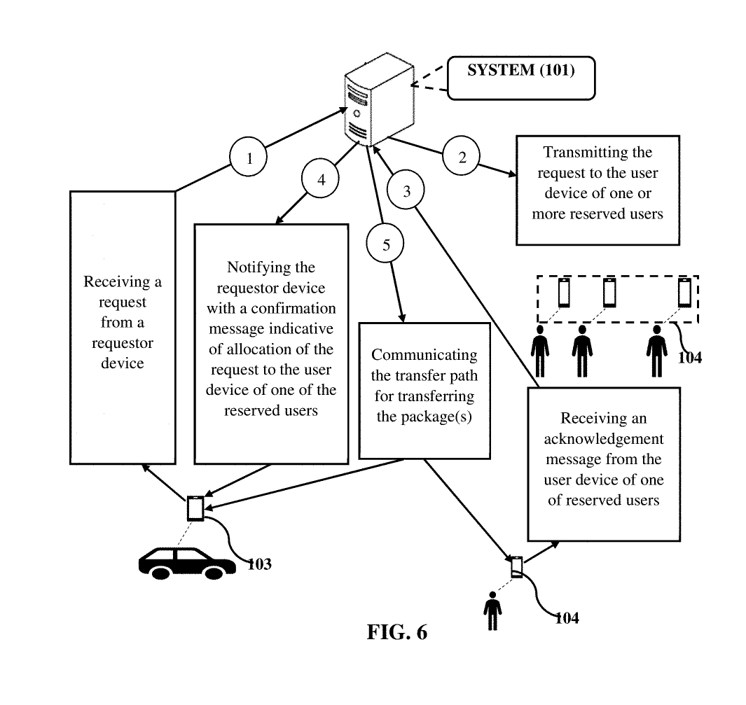

In another embodiment, the system 101 may facilitate “assisted drop-off” in the case of a dispatch request of a drop-off. FIG. 5 illustrates the assisted drop-off facility, in accordance with an embodiment of the present disclosure. In this assisted drop-off facility, the system 101 may identify one or more user devices associated with the users located within the predefined distance from any point on the vehicular path of the vehicle associated with the requestor device on route to the drop-off location, if none of the user devices associated with the plurality of users are located within the predefined distance from the closest geospatial point on the transfer path relative to the respective user devices associated with the plurality of users. In one embodiment, the system 101 may enable boarding of a user, by the vehicle associated with the requestor device 103, from an assisted embark location (i.e. assisted embark point) for drop-off on the vehicular path on route to the drop-off location. In one embodiment, the system 101 may compute for each user device of the users, the shortest geospatial distance of the respective user device to the vehicular path on route to the drop-off location. The requestor device 103 or the system 101 may select a disembark location for a drop-off to disembark the user of the user device 104. From the disembark location, the user of the user device 104 then transfers out the package(s) from the vehicle associated with the requestor device and then proceeds to drop off the package(s) at the drop-off location.

Now referring to FIG. 6, a dispatch request assigned to one of reserved set of users by the system 101 is illustrated, in accordance with an embodiment of the present disclosure. In this embodiment, after the initiation of the dispatch request for a pick-up/drop-off associated with the said dispatch by the requestor device 103, the system 101 may assign a user device from a set of user devices reserved (hereafter referred as reserved set of user devices) for handling the dispatch requests for a fixed geospatial location associated with a physical location (e.g. office premise, shopping mall, privately owned property, hospitality area, etc.). In this embodiment, an authorized entity of the said fixed geospatial location may claim ownership of the said fixed geospatial location with the system 101. In one embodiment, the system 101 may verify the validity of the claim of ownership of the geospatial location. Upon verification, the authorized entity may request the system 101 to allocate the reserved set of user devices for processing the dispatch requests (dispatch requests for either pick-up or drop-off) pertaining to pick-up or drop-off locations with a geospatial overlap with the owner's location. Therefore, for any dispatch request for a pick-up received by the system 101, the system 101 may directly assign the dispatch request for a pick-up to one of the set of reserved user devices pre-allocated to the owner's verified location. Similarly, for any dispatch request for a drop-off received by the system 101, the system 101 may directly assign the dispatch request for a drop-off to one of the set of reserved user devices pre-allocated to the owner's verified location. In this embodiment, the reserved set of user devices may act as users dedicated for processing the dispatch requests pertaining to the owner's verified physical location. The system 101 may not compute the score for each of the reserved set of the user devices 104 but directly broadcast the dispatch request for a pick-up/drop-off to the reserved set of user devices pre-allocated to the owner's verified location with geospatial overlap with the pick-up/drop-off location provided in the dispatch request received by the system 101. In this exemplary embodiment, the system 101 may prioritize the reserved set of user devices online, for processing the said dispatch request. However, if none of the reserved set of user devices is engaged with lesser than a predefined threshold of other concurrent dispatch request(s), the system 101 may wait for a predefined time interval until one of the reserved set of user devices is identified with a number of other concurrent dispatch requests lesser than the predefined threshold. In one embodiment, the system 101 may then allocate the said dispatch request to one of the reserved set of user devices identified to be engaged with a number of other concurrent dispatch requests lesser than the predefined threshold.

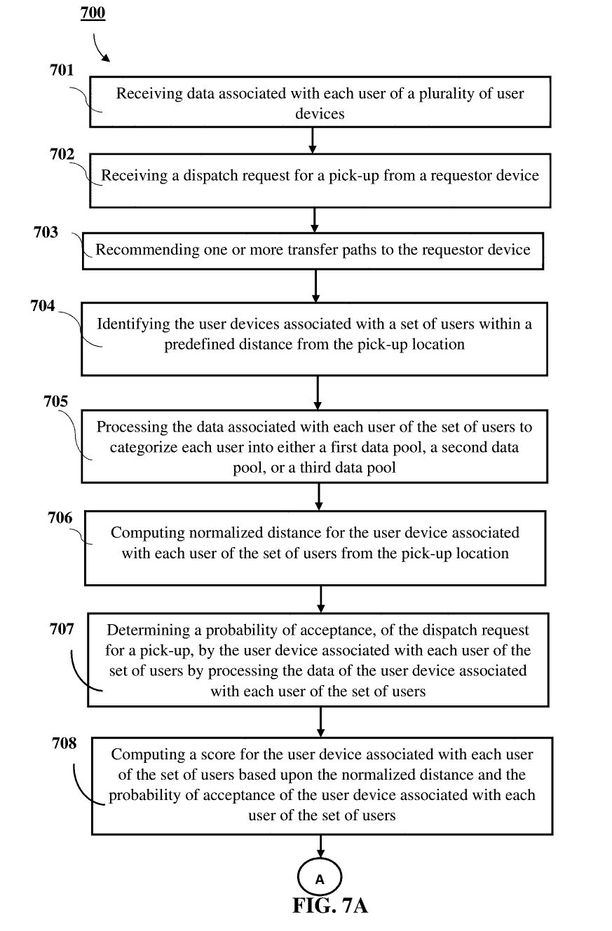

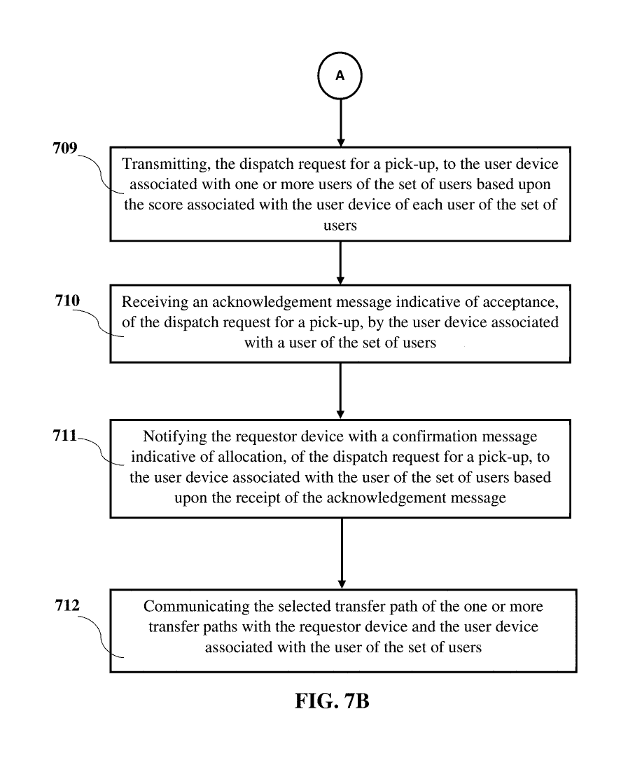

Now referring to FIG. 7A and FIG. 7B, a method for real time delivery segmentation in logistics for a dispatch request for a pick-up is illustrated, in accordance with the present subject matter. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices. The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof. However, for ease of explanation, in the embodiments described below, the method 700 may be considered to be implemented in the above described system 101.

Referring to FIG. 7A, at step 701, the system 101 may receive data associated with each user of a plurality of user devices 104. In one exemplary embodiment, the data may at least include name, address, phone number and other credentials associated with the users of the user devices.

At step 702, the system 101 may receive a dispatch request for a pick-up from the requestor device 103. In one embodiment, the dispatch request for a pick-up may be indicative of picking up the package(s) from the pick-up location.

At step 703, the system 101 may recommend one or more transfer paths to the requestor device. Each transfer path is a polygonal chain of geospatial points. In one embodiment, the transfer path from the one or more transfer paths may be selected by the requestor device 103 or by the processor 201.

At step 704, the system 101, via the identification module 205, may identify the user devices associated with a set of users, of the plurality of users, located within a predefined distance from the pick-up location. The set of users may be the users located within the predefined distance from the pick-up location.

At step 705, the system 101, via the processing module 206, may process the data associated with each user of the set of users. In one embodiment, the processing module 206 may categorize each user of the set of users into one of actively online devices, passively online devices, and partially engaged devices, based upon predefined parameters. In one embodiment, the predefined parameters may include, but not limited to, one or more of: distance from the pick-up location, transportation mode (i.e. walking, cycling, or operating a SEGWAY® etc.), current mode of the user of the user device (i.e. partially engaged or the mode selected by the user as either actively online or passively online), and status(es) of dispatch request(s) assigned to the user.

At step 706, the system 101, via the processing module 206, may be configured to compute normalized distance from the pick-up location for a pick-up, for the user device associated with each user of the set of users categorized in either of the actively online devices, the passively online devices, or the partially engaged devices.

At step 707, the system 101, via the processing module 206, determines the probability of acceptance, of the dispatch request for a pick-up, by the user device associated with each user of the set of users categorized in either of the actively online devices, the passively online devices, or the partially engaged devices.

At step 708, the system 101, via the processing module 206, computes the score for the user device associated with each user of the set of users based upon the normalized distance and the probability of acceptance of the user device associated with each user of the set of users.

Now referring to FIG. 7B, at step 709, the system 101, via the transmission module 207, may transmit the dispatch request for a pick-up to the user device associated with one or more users of the set of users based upon the score of the user device associated with each user of the set of users.

At step 710, the system 101 may receive an acknowledgement message indicative of acceptance, of the dispatch request for a pick-up, by the user device associated with the user of the set of users.

At step 711, the system 101, via the transmission module 207, may notify the requestor device with a confirmation message indicative of allocation, of the dispatch request for a pick-up, to the user device associated with the user of the set of users, based upon the receipt of the acknowledgement message.

At step 712, the system 101, via the transmission module 207, may communicate the selected transfer path with the requestor device and the user device associated with the user of the set of users.

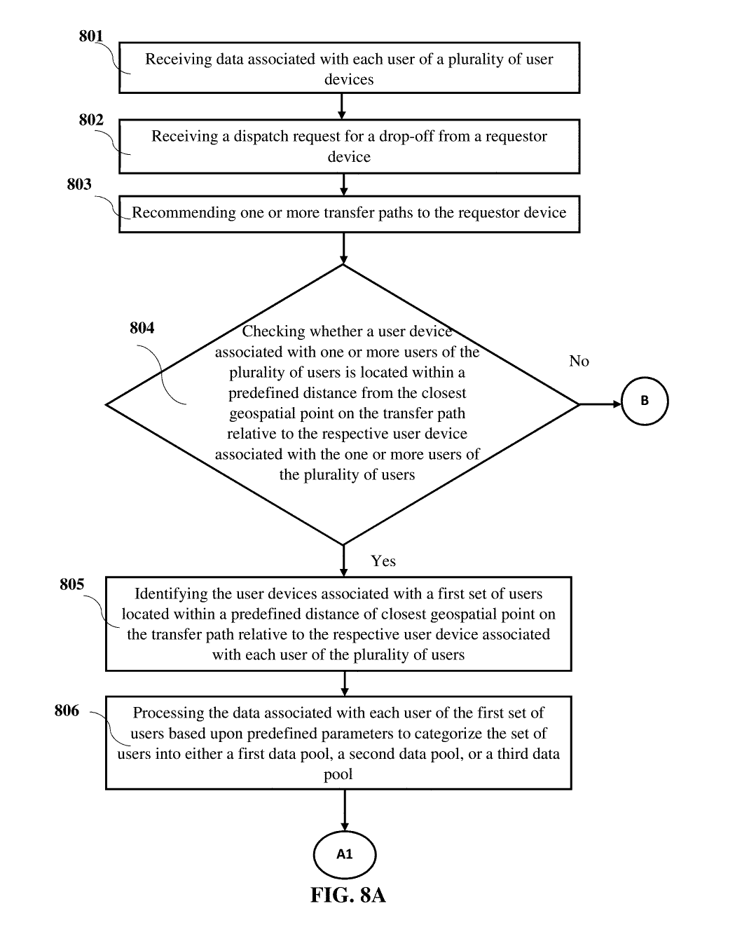

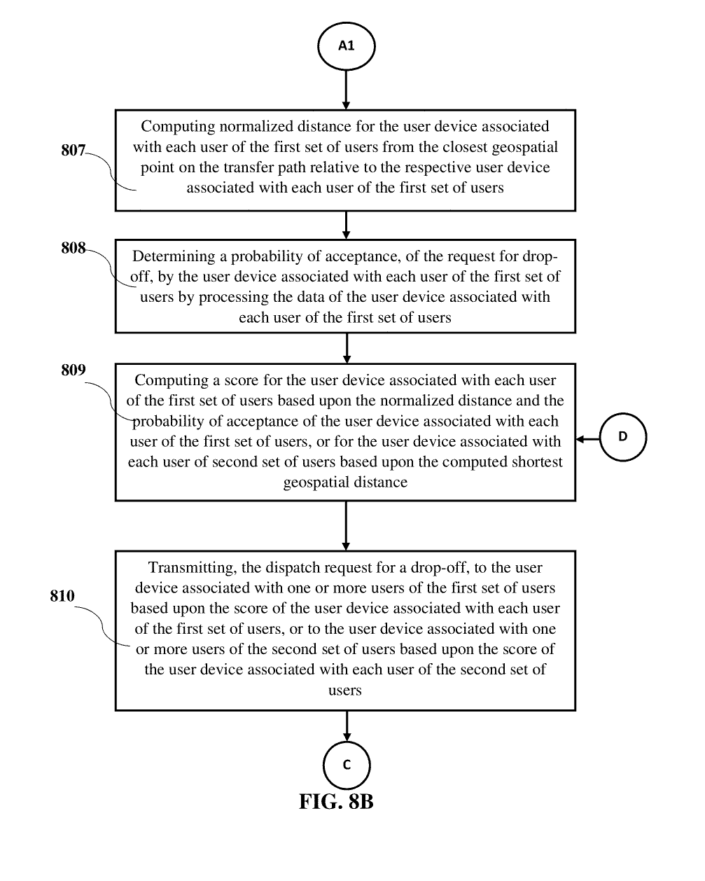

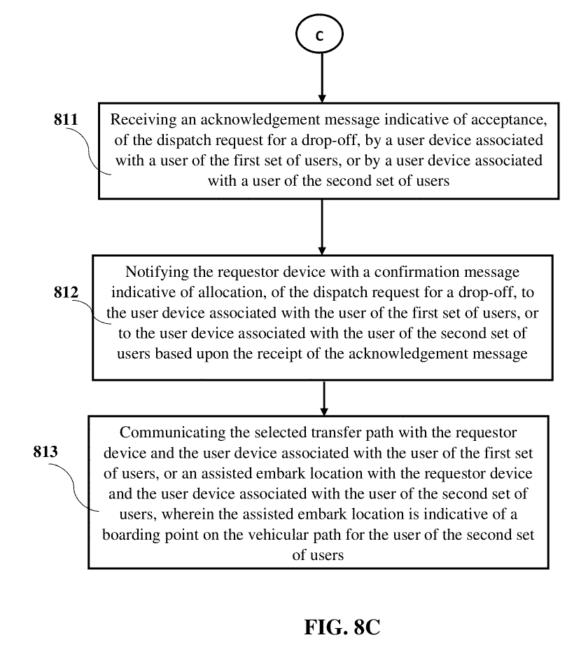

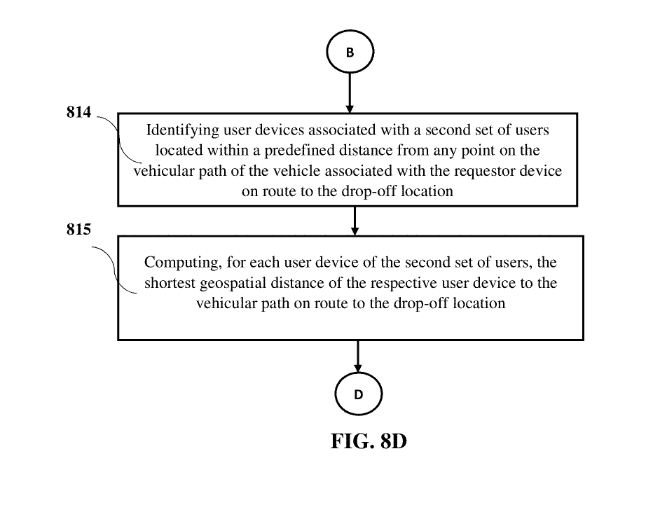

Now referring to FIG. 8A, FIG. 8B, FIG. 8C and FIG. 8D, a method for real time delivery segmentation in logistics for a dispatch request for a drop-off is illustrated, in accordance with the present subject matter.

Referring to FIG. 8A, at step 801, the system 101 may receive data associated with each user of a plurality of user devices 104. In one exemplary embodiment, the data may at least include name, address, phone number and other credentials associated with the users of the user devices.

At step 802, the system 101 may receive a dispatch request for a drop-off from the requestor device 103. In one embodiment, the dispatch request for a drop-off may be indicative of dropping off the package(s) to the drop-off location.

At step 803, the system 101 may recommend one or more transfer paths to the requestor device. Each transfer path is a polygonal chain of geospatial points. In one embodiment, the transfer path from the one or more transfer paths may be selected by the requestor device or by the processor 201.

At step 804, the system 101 may check whether a user device associated with one or more users of the plurality of users is located within a predefined distance from the closest geospatial point on the transfer path relative to the respective user device associated with the one or more users of the plurality of users. If the user device associated with the one or more users of the plurality of users is located within the predefined distance from the closest geospatial point on the transfer path relative to the respective user device associated with the one or more users of the plurality of users, then at step 805, the system 101, via the identification module 205, may identify the user devices associated with the first set of users, of the plurality of users, located within the predefined distance from the closest geospatial point on the transfer path relative to the respective user device associated with each user of the plurality of users. The user devices of the first set of users may be the user devices located within the predefined distance from the closest geospatial point on the transfer path relative to the respective user device associated with each user of the plurality of users.

At step 806, the system 101, via the processing module 206, may process the data associated with each user of the first set of users. In one embodiment, the processing module 206 may categorize each user of the first set of users into one of actively online devices, passively online devices, and partially engaged devices, based upon predefined parameters. In one embodiment, the predefined parameters may include, but not limited to, one or more of: distance from the drop-off location, transportation mode (i.e. walking, cycling, or operating a SEGWAY® etc.), current mode of the user of the user device (i.e. partially engaged or the mode selected by the user as either actively online or passively online), and status(es) of dispatch request(s) assigned to the user.

Now referring to FIG. 8B, at step 807, the system 101, via the processing module 206, may be configured to compute normalized distance for the user device associated with each user of the first set of users (categorized in either of the actively online devices, the passively online devices, or the partially engaged devices) from the closest geospatial point on the transfer path relative to the respective user device associated with each user of the first set of users.

At step 808, the system 101, via the processing module 206, determines the probability of acceptance, of the dispatch request for a drop-off, by the user device associated with each user of the first set of users categorized in either of the actively online devices, the passively online devices, or the partially engaged devices.

Now referring to FIG. 8A and 8D, if none of the user devices associated with the plurality of users are located within the predefined distance from the closest geospatial point on the transfer path relative to the respective user devices associated with the plurality of users, then at step 814, the identification module 205 of the system 101 may identify user devices associated with a second set of users, located within a predefined distance from any point on the vehicular path of the vehicle associated with the requestor device 103 on route to the drop-off location.

Now referring to FIG. 8D, at step 815, the processing module 206 may compute for each user device of the second set of users, the shortest geospatial distance of the respective user device to the vehicular path on route to the drop-off location.

Now referring to FIG. 8B, at step 809, the system 101, via the processing module 206, computes the score for the user device associated with each user of the first set of users located based upon the normalized distance and the probability of acceptance of the user device associated with each user of the first set of users, or for the user device associated with each user of second set of users based upon the computed shortest geospatial distance.

At step 810, the system 101, via the transmission module 207, may transmit the dispatch request for a drop-off to the user device associated with one or more users of the first set of users based upon the score of each user device associated with the first set of users, or to the user device associated with one or more users of the second set of users based upon the score of each user device associated with the second set of users.

Now, referring to FIG. 8C, at step 811, the system 101 may receive an acknowledgement message indicative of acceptance, of the dispatch request for a drop-off, by a user device associated with a user of the first set of users, or by a user device associated with a user of the second set of users.

At step 812, the system 101, via the transmission module 207, may notify the requestor device with a confirmation message indicative of allocation, of the dispatch request for a drop-off, to the user device associated with the user of the first set of users, or to the user device associated with the user of the second set of users, based upon the receipt of the acknowledgement message.

At step 813, the system 101, via the transmission module 207, may communicate the selected transfer path with the requestor device and the user device associated with the user of the first set of users, or an assisted embark location with the requestor device and the user device associated with the user of the second set of users, wherein the assisted embark location is indicative of a boarding point on the vehicular path for the user of the second set of users.

It must be noted herein that once the vehicle associated with the requestor device 103 reaches the transfer path, the vehicle may enable the user of the user device 104 to transfer the package(s) into the respective vehicle for further transition/dispatch of the package(s), thereby completing the processing of the dispatch request for a pick-up; or transfer-out the package(s) from the respective vehicle and drop-off to the intended receiver thereby completing the processing of the dispatch request for a drop-off.

Although implementations systems and methods for real time delivery segmentation in logistics have been described in language specific to structural features and/or methods, it is to be understood that the appended claims are not necessarily limited to the specific features or methods described. Rather, the specific features and methods are disclosed as examples of implementations for real time delivery segmentation in logistics.

What is claimed is:

1. A computer implemented system for real time delivery segmentation in logistics, the system comprising:
a processor; and
a memory coupled with the processor, wherein the processor is communicatively coupled with a requestor device, and a plurality of user devices, wherein the processor is configured to execute instructions stored in the memory for
receiving data associated with each user of the plurality of user devices;
receiving a dispatch request for a pick-up from the requestor device;
recommending one or more transfer paths to the requestor device, wherein each transfer path is a polygonal chain of geospatial points, wherein a transfer path from the one or more transfer paths is selected by the requestor device or the processor;
identifying the user devices associated with a set of users, of the plurality of users, located within a predefined distance of a pick-up location;
processing the data associated with each user of the set of users based upon predefined parameters to categorize the set of users into either a first data pool, a second data pool, or a third data pool;
computing normalized distance for the user device associated with each user of the set of users, categorized in either of the first data pool, the second data pool, or the third data pool, from the pick-up location;
determining a probability of acceptance, of the dispatch request for a pick-up, by the user device associated with each user of the set of users, categorized in either of the first data pool, the second data pool, or the third data pool, by processing the data of the user device associated with each user of the set of users;
computing a score for the user device associated with each user of the set of users based upon the normalized distance and the probability of acceptance of the user device associated with each user of the set of users;
transmitting, the dispatch request for a pick-up, to the user device associated with one or more users of the set of users based upon the score of each user device associated with the set of users;
receiving an acknowledgement message indicative of acceptance, of the dispatch request for a pick-up, by a user device associated with a user of the set of users;
notifying the requestor device with a confirmation message indicative of allocation, of the dispatch request for a pick-up, to the user device associated with the user of the set of users, based upon the receipt of the acknowledgement message; and
communicating the selected transfer path with the requestor device and the user device associated with the user of the set of users.

2. The system of claim 1, wherein the dispatch request for a pick-up further comprises one or more of: an order identifier (ID), a job identifier, a pick-up location name, geo-coordinates of the pick-up location, and an order source.

3. The system of claim 1, wherein the first data pool comprises a list of all user devices associated with the users with current mode of actively online and geospatially present within a first predefined distance from the pick-up location, who have not rejected the said dispatch request for a pick-up, and who are not assigned with the said dispatch request.

4. The system of claim 1, wherein the second data pool comprises a list of all user devices associated with the users with current mode of passively online and geospatially present within a second predefined distance from the pick-up location, who have not rejected the said dispatch request for a pick-up, and who are not assigned with the said dispatch request.

5. The system of claim 1, wherein the third data pool comprises a list of all user devices associated with users who are currently assigned to one or more dispatch requests and wherein none of the assigned dispatch requests have their associated vehicles with Estimated Time of Arrival (ETA) from the transfer path as less than a predefined time interval from the vehicle's, associated with the requestor device, Estimated Time of Arrival (ETA) from the transfer path, and the user device associated with the user is located within a predefined distance from the transfer path, and the user device associated with the user has not already rejected the said dispatch request.

6. The system of claim 1, wherein the probability of acceptance is determined by processing data in context of dispatch requests for a pick-up, previously accepted or rejected by each user of the set of users, wherein the data being processed comprises one or more of: distance from the pick-up location, transportation mode, geo-coordinates of the user, time of the day, the current mode of the user, wherein the current mode is either one of the modes comprising actively online, passively online, or partially engaged, current status of the assigned dispatch request of the user if any, the time series of the geo-coordinates of the user in a past predefined time period, wherein the probability of acceptance is represented by confidence level within a range of 0 and 1.

7. The system of claim 6, further performing sorting of a list of user devices associated with the users, in ascending order using the score obtained using a predefined formula:
[Normalized distance×k (1−Probability of acceptance)], wherein k is a predefined constant.

8. The system of claim 1, wherein the system directly transmits, the dispatch request for a pick-up, to one of a reserved set of user devices, specifically dedicated for handling the dispatch requests for a pick-up, for a fixed geospatial location associated with a particular physical location, wherein the reserved set of user devices are pre-registered with the system by the authorized entity of the said particular physical location.

9. The system of claim 1, wherein the system further provides recommendations for the transfer path to the requestor device for transferring the package(s), wherein the recommendations are based on the pick-up location, side of the road the vehicles drive in a particular country, real time traffic details within a predefined radius of the pick-up location, third-party location data, and the historical data of the dispatch requests completed by the system, processed as inputs to a machine learning model

10. The system of claim 1, wherein the system transmits, the dispatch request for a pick-up, in the form of a staggered dispatch, wherein the staggered dispatch comprises transmitting the dispatch request to the user device associated with a user of the sorted list; if the user fails to respond to the said dispatch request within a predefined threshold duration, then the said user is added to a stagger dispatched pool of users, wherein the stagger dispatched pool of users includes one or more users who have been transmitted the said dispatch request but have not responded to the said dispatch request within the predefined threshold duration, wherein the system further transmits, the dispatch request for a pick-up, to the subsequent user of the sorted list, and wherein the system allocates the dispatch request to the user, either from the stagger dispatched pool of users or the subsequent user, who responds first.

11. A computer implemented system for real time delivery segmentation in logistics, the system comprising:
processor; and
a memory coupled with the processor, wherein the processor is communicatively coupled with a requestor device, and a plurality of user devices, wherein the processor is configured to execute instructions stored in the memory for
receiving data associated with each user of the plurality of user devices;
receiving a dispatch request for a drop-off from the requestor device;
recommending one or more transfer paths to the requestor device, wherein each transfer path is a polygonal chain of geospatial points, wherein the transfer path from the one or more transfer paths is selected by the requestor device or the processor;
checking whether a user device associated with one or more users of the plurality of users is located within a predefined distance from the closest geospatial point on the transfer path relative to the respective user device associated with the one or more users of the plurality of users;
If the one or more users of the plurality of users are located within the predefined distance from the closest geospatial point on the transfer path relative to the respective user device associated with the one or more users of the plurality of users, then
identifying the user devices associated with a first set of users, of the plurality of users, located within the predefined distance from the closest geospatial point on the transfer path relative to the respective user device associated with each user of the plurality of users;
processing the data associated with each user of the first set of users based upon predefined parameters to categorize the first set of users into either a first data pool, a second data pool, or a third data pool;
computing normalized distance for the user device associated with each user of the first set of users, categorized in either of the first data pool, the second data pool, or the third data pool, from the closest geospatial point on the transfer path relative to the respective user device associated with each user of the first set of users;
determining a probability of acceptance, of the dispatch request for a drop-off, by the user device associated with each user of the first set of users, categorized in either of the first data pool, the second data pool, or the third data pool, by processing the data of the user device associated with each user of the first set of users; else
identifying user devices associated with a second set of users located within a predefined distance from any point on the vehicular path of a vehicle associated with the requestor device on route to the drop-off location;
computing for each user device of the second set of users, the shortest geospatial distance of the respective user device to the vehicular path of the vehicle associated with the requestor device on route to the drop-off location;
computing a score,
for the user device associated with each user of the first set of users based upon the normalized distance and the probability of acceptance of the user device associated with each user of the first set of users; or
for the user device associated with each user of second set of users based upon the computed shortest geospatial distance;
transmitting, the dispatch request for a drop-off, to the user device associated with one or more users of the first set of users based upon the score of each user device associated with the first set of users, or to the user device associated with one or more users of the second set of users based upon the score of each user device associated with the second set of users;
receiving an acknowledgement message indicative of acceptance, of the dispatch request for a drop-off, by a user device associated with a user of the first set of users, or by a user device associated with a user of the second set of users;
notifying the requestor device with a confirmation message indicative of allocation, of the dispatch request for a drop-off, to the user device associated with the user of the first set of users, or to the user device associated with the user of the second set of users, based upon the receipt of the acknowledgement message; and
communicating the selected transfer path with the requestor device and the user device associated with the user of the first set of users, or an assisted embark location with the requestor device and the user device associated with the user of the second set of users, wherein the assisted embark location is indicative of a boarding point on the vehicular path for the user of the second set of users.

12. The system of claim 11, wherein the dispatch request for a drop-off further comprises one or more of: an order identifier (ID), a job identifier, an order source, a drop-off location name, and geo-coordinates of the drop-off location.

13. The system of claim 11, wherein the first data pool comprises a list of all user devices associated with the users with a current mode of actively online and geospatially present within a first predefined distance from the closest geospatial point on the transfer path relative to the respective user devices associated with the first set of users, who have not rejected the said dispatch request for a drop off, and who are not assigned with the said dispatch request.

14. The system of claim 11, wherein the second data pool comprises a list of all user devices associated with the users with current mode of passively online, and geospatially present within a second predefined distance from the closest geospatial point on the transfer path relative to the respective user devices associated with the first set of users, who have not rejected the said dispatch request for a drop-off, and who are not assigned with the said dispatch request.

15. The system of claim 11, wherein the third data pool comprises a list of all user devices associated with users who are currently assigned to one or more dispatch requests and wherein none of the assigned dispatch requests have their associated vehicles with Estimated Time of Arrival (ETA) from the transfer path as less than a predefined time interval from the vehicle's, associated with the requestor device, Estimated Time of Arrival (ETA) from the transfer path, and the user device associated with the user is located within a predefined distance from the transfer path, and the user device associated with the user has not rejected the said dispatch request.

16. The system of claim 11, wherein the probability of acceptance is determined by processing data in context of dispatch requests for a drop-off previously accepted or rejected by each user of the set of users, wherein the data being processed comprises one or more of: distance from the transfer path, transportation mode, geo-coordinates of the user, time of the day, a day of a week, real-time weather report, the current mode of the user wherein the current mode is either one of the modes comprising actively online, passively online, or partially engaged, current status of the assigned dispatch request of the user if any, the time series of geo-coordinates in a past predefined time of the user, wherein the probability of acceptance is represented by confidence level within a range of 0 and 1.

17. The system of claim 16, further performing sorting of a list of user devices associated with the users, in ascending order using the score obtained using a predefined formula:
[Normalized distance×k (1−Probability of acceptance)], wherein k is a predefined constant.

18. The system of claim 11, wherein the system directly transmits, the dispatch request for a drop-off, to one of a reserved set of user devices, specifically dedicated for handling the dispatch requests for a drop-off, for a fixed geospatial location associated with a particular physical location, wherein the reserved set of user devices are pre-registered with the system by the authorized entity of the said particular physical location.

19. The system of claim 11, wherein the system further provides recommendations for transfer paths to the requestor device for transferring the package(s), wherein the recommendations are based on the drop-off location, side of the road the vehicles drive in a particular country, real time traffic details within predefined radius of the drop-off location, third-party location data, and historical data of dispatch requests completed by the system, processed as inputs to a machine learning model

20. The system of claim 11, wherein the system transmits, the dispatch request for a drop-off, in the form of a staggered dispatch, wherein the staggered dispatch comprises transmitting the dispatch request to the user device associated with a user of the sorted list of the first set of users, or to the user device associated with a user of the second set of users with a maximum score based on the computed shortest geospatial distance; if the user fails to respond to the said dispatch request within a predefined threshold duration, then the said user is added to a stagger dispatched pool of users, wherein the stagger dispatched pool of users includes one or more users who have been transmitted the said dispatch request but have not responded to the said dispatch request within the predefined threshold duration, wherein the system further transmits, the dispatch request for a drop-off, to a subsequent user of the sorted list of the first set of users, or to the user device associated with a subsequent user of the second set of users with the maximum score based on the computed shortest geospatial distance, and wherein the system allocates the dispatch request for a drop-off to the user, either of the stagger dispatched pool of users or the subsequent user of the sorted list of the first set of users or the subsequent user of the second set of users, who responds first.

21. A method for real time delivery segmentation in logistics, the method comprising:
receiving, via a processor, data associated with each user of a plurality of user devices;
receiving, via the processor, a dispatch request for a pick-up from a requestor device;
recommending, via the processor, one or more transfer paths to the requestor device, wherein each transfer path is a polygonal chain of geospatial points, wherein a transfer path from the one or more transfer paths is selected by the requestor device or the processor;
identifying, via the processor, the user devices associated with a set of users, of the plurality of users, located within a predefined distance of a pick-up location;
processing, via the processor, the data associated with each user of the set of users based upon predefined parameters to categorize the set of users into either a first data pool, a second data pool, or a third data pool;
computing, via the processor, normalized distance for the user device associated with each user of the set of users, categorized in either of the first data pool, the second data pool, or the third data pool, from the pick-up location;
determining, via the processor, a probability of acceptance, of the dispatch request for a pick-up, by the user device associated with each user of the set of users, categorized in either of the first data pool, the second data pool, or the third data pool, by processing the data of the user device associated with each user of the set of users;
computing, via the processor, a score for the user device associated with each user of the set of users based upon the normalized distance and the probability of acceptance of the user device associated with each user of the set of users;
transmitting, via the processor, the dispatch request for a pick-up to the user device associated with one or more users of the set of users based upon the score of each user device associated with the set of users;
receiving, via the processor, an acknowledgement message indicative of acceptance, of the dispatch request for a pick-up, by a user device associated with a user of the set of users;
notifying, via the processor, the requestor device with a confirmation message indicative of allocation, of the dispatch request for a pick-up, to a user device associated with the user of the set of users, based upon the receipt of the acknowledgement message; and
communicating, via the processor, the selected transfer path with the requestor device and the user device associated with the user of the set of users.

22. The method of claim 21 further comprising sorting of a list of user devices associated with the users, in ascending order using the score obtained using a predefined formula:
[Normalized distance×k (1−Probability of acceptance)], wherein k is a predefined constant.

23. The method of claim 21, wherein the dispatch request for a pick-up is directly transmitted to one of a reserved set of user devices, specifically dedicated for handling the dispatch requests for a pick-up, for a fixed geospatial location associated with a particular physical location, wherein the reserved set of user devices are pre-registered with the system by the authorized entity of the said particular physical location.

24. The method of claim 21 further comprising providing recommendations for transfer paths to the requestor device for transferring the package(s), wherein the recommendations are based on the pick-up location, side of the road the vehicles drive in a particular country, real time traffic details within a predefined radius of the pick-up location, third-party location data, and historical data of the dispatch requests completed by the system, processed as inputs to a machine learning model.

25. The method of claim 21, wherein the staggered dispatch comprises transmitting the dispatch request to the user device associated with a user of the sorted list; if the user fails to respond to the said dispatch request within a predefined threshold duration, then the said user is added to a stagger dispatched pool of users, wherein the stagger dispatched pool of users includes one or more users who have been transmitted the said dispatch request but have not responded to the said dispatch request within the predefined threshold duration, wherein the method further comprises transmitting, the dispatch request for a pick-up, to the subsequent user of the sorted list, and wherein the method further comprises allocating the dispatch request to the user, either from the stagger dispatched pool of users or the subsequent user, who responds first.

26. A method for real time delivery segmentation in logistics, the method comprising:
receiving, via a processor, data associated with each user of a plurality of user devices;
receiving, via the processor, a dispatch request for a drop-off from a requestor device;
recommending, via the processor, one or more transfer paths to the requestor device, wherein each transfer path is a polygonal chain of geospatial points, wherein a transfer path from the one or more transfer paths is selected by the requestor device or the processor;
checking, via the processor, whether a user device associated with one or more users of the plurality of users is located within a predefined distance from the closest geospatial point on the transfer path relative to the respective user device associated with the one or more users of the plurality of users;
If the user device associated with the one or more users of the plurality of users is located within the predefined distance from the closest geospatial point on the transfer path relative to the respective user devices associated with the one or more users of the plurality of users, then
identifying, via the processor, the user devices associated with a first set of users, of the plurality of users, located within the predefined distance from closest geospatial point on the transfer path relative to the respective user device associated with each user of the plurality of users;
processing, via the processor, the data associated with each user of the first set of users based upon predefined parameters to categorize the first set of users into either a first data pool, a second data pool, or a third data pool;
computing, via the processor, normalized distance for the user device associated with each user of the first set of users, categorized in either of the first data pool, the second data pool, or the third data pool, located from the closest geospatial point on the transfer path relative to the respective user device associated with each user of the first set of users;
determining, via the processor, a probability of acceptance, of the dispatch request for a drop-off, by the user device associated with each user of the first set of users, categorized in either of the first data pool, the second data pool, or the third data pool, by processing the data of the user device associated with each user of the first set of users; else
identifying, via the processor, user devices associated with a second set of users, located within a predefined distance from any point on the vehicular path of a vehicle associated with the requestor device on route to the drop-off location;
computing, via the processor, for each user device of the second set of users, the shortest geospatial distance of the respective user device to the vehicular path on route to the drop-off location;
computing, via the processor, a score for the user device associated with each user of the first set of users based upon the normalized distance and the probability of acceptance of the user device associated with each user of the set of users, or for the user device associated with each user of second set of users based upon the computed shortest geospatial distance;
transmitting, via the processor, the dispatch request for a drop-off to a user device associated with one or more users of the first set of users based upon the score of each user device associated with the first set of users, or to a user device associated with one or more users of the second set of users based upon the score of each user device associated with the second set of users;
receiving, via the processor, an acknowledgement message indicative of acceptance, of the dispatch request for a drop-off, by a user device associated with a user of the first set of users, or by a user device associated with a user of the second set of users;
notifying, via the processor, the requestor device with a confirmation message indicative of allocation, of the dispatch request for a drop-off, to the user device associated with the user of the first set of users, or to the user device associated with the user of the second set of users, based upon the receipt of the acknowledgement message; and
communicating, via the processor, the selected transfer path with the requestor device and the user device associated with the user of the first set of users, or an assisted embark location with the requestor device and the user device associated with the user of the second set of users, wherein the assisted embark location is indicative of a boarding point on the vehicular path for the user of the second set of users.

27. The method of claim 26, further comprising sorting of a list of user devices associated with the first set of users, in ascending order using the score obtained using a predefined formula:
[Normalized distance×k (1−Probability of acceptance)], wherein k is a predefined constant.

28. The method of claim 26, wherein the dispatch request for a drop-off is directly transmitted to one of a reserved set of user devices, specifically dedicated for handling the dispatch requests for a drop-off, for a fixed geospatial location associated with a particular physical location, wherein the reserved set of user devices are pre-registered with the system by the authorized entity of the said particular physical location.

29. The method of claim 26 further comprising providing recommendations for transfer paths to the requestor device for transferring the package(s), wherein the recommendations are based on the drop-off location, side of the road the vehicles drive in a particular country, real time traffic details within a predefined radius of the drop-off location, third-party location data, and historical data of the dispatch requests completed by the system, processed as inputs to a machine learning model.

30. The method of claim 26 further comprising transmitting the dispatch request for a drop-off in the form of a staggered dispatch, wherein the staggered dispatch comprises transmitting the dispatch request to the user device associated with a user of the sorted list of the first set of users, or to the user device associated with a user of the second set of users with a maximum score based on the computed shortest geospatial distance; if the user fails to respond to the said dispatch request within a predefined threshold duration, then the said user is added to a stagger dispatched pool of users, wherein the stagger dispatched pool of users includes one or more users who have been transmitted the said dispatch request but have not responded to the said dispatch request within the predefined threshold duration, wherein the method further comprises transmitting, the dispatch request for a drop-off, to a subsequent user of the sorted list of the first set of users, or to the user device associated with a subsequent user of the second set of users with the maximum score based on the computed shortest geospatial distance, and wherein the method further comprises allocating the dispatch request for a drop-off to the user, either of the stagger dispatched pool of users or the subsequent user of the sorted list of the first set of users or the subsequent user of the second set of users, who responds first.
